(19) United States
(12) Patent Application Publication
(10) Pub. No.: US 2023/0091380 A1
(43) Pub. Date: Mar. 23, 2023

(54) LITHIUM-METAL COMPATIBLE SOLID ELECTROLYTES FOR ALL-SOLID-STATE BATTERY

(71) Applicant: Battelle Memorial Institute, Richland, WA (US)

(72) Inventors: Zhaoxin Yu, Richland, WA (US); Dongping Lu, Richland, WA (US)

(73) Assignee: Battelle Memorial Institute, Richland, WA (US)

(21) Appl. No.: 17/945,447

(22) Filed: Sep. 15, 2022

Related U.S. Application Data
(60) Provisional application No. 63/245,432, filed on Sep. 17, 2021.

(51) Int. Cl. H01M 10/0562; H01M 10/052

(52) U.S. Cl. CPC H01M 10/0562; H01M 10/052; H01M 2300/0068

(57) ABSTRACT

Solid composite electrolytes include (i) an amorphous matrix comprising one or more lithiophilic elements and (ii) lithium-based electrolyte crystals at least partially embedded in the amorphous matrix, the lithium-based electrolyte crystals having a different chemical composition than the amorphous matrix. After the composite is compressed or cycled in a battery, a surface portion of the composite has a concentration of the lithiophilic element(s) that is greater than an average concentration of the lithiophilic element(s) in a bulk portion of the composite.

### CROSS REFERENCE TO RELATED APPLICATION

This application claims the benefit of the earlier filing date of U.S. Provisional Application No. 63/245,432, filed Sep. 17, 2021, which is incorporated by reference in its entirety herein.

### ACKNOWLEDGMENT OF GOVERNMENT SUPPORT

This invention was made with Government support under Contract DE-AC0576RL01830 awarded by the U.S. Department of Energy. The Government has certain rights in the invention.

### FIELD

Lithium metal-compatible solid electrolytes for use in all-solid-state batteries are disclosed, as well as all-solid-state batteries including the solid electrolytes, and methods of making the solid electrolytes.

### BACKGROUND

All-solid-state lithium batteries (ASSLBs) have been proposed and pursued intensively as a potential candidate for the next-generation energy storage devices because of their superior energy/power densities and advanced safety characteristics. Solid-state electrolytes (SSEs) with high ionic conductivity and/or good lithium metal compatibility are advantageous for ASSLBs. However, most SSEs, especially sulfide-based SSEs are unstable when in contact with Li metal. They tend to decompose rapidly and form resistive solid electrolyte interface (SEI). The poorly Li⁺ conductive (SEI), mainly composed of Li₂S and Li₃P, results in the low and nonuniform Li⁺ flux at the SSE/Li interface and eventually leads to the Li dendrite formation during Li plating, shorting the cell. Therefore, a need exists in the art for a novel SSE that has a high ionic conductivity and is stable against Li metal anodes with a low interfacial resistance.

### SUMMARY

Solid electrolytes for lithium metal batteries are disclosed, as well as batteries including the solid electrolytes and methods of making the solid electrolytes. In some aspects, a solid electrolyte comprises a compressed composite. Prior to cycling, the compressed composite includes (i) an amorphous matrix comprising an ionic compound or an alloy, the ionic compound or the alloy having a formula of Li_{y}Z, where Z is I, Br, Cl, F, Mg, B, N, Al, Si, Zn, Ag, Pt, or any combination thereof, and y is a value selected to provide the alloy or to provide the ionic compound with a neutral net charge; and (ii) lithium-based electrolyte crystals at least partially embedded in the amorphous matrix, the lithium-based electrolyte crystals having a different chemical composition than the amorphous matrix. A surface portion of the compressed composite has a concentration of Z that is from 1% greater to 60% greater than an average concentration of Z within a bulk portion of the compressed composite. In some implementations, the compressed composite is formed under a pressure ≥450 MPa.

In any of the foregoing or following aspects, the lithium-based electrolyte crystals may comprise Li₆P₂S₈, Li₇La₃Zr₂O₁₂, Li_{1.3}Al_{0.3}Ti_{1.7}(PO₄)₃, Li₁₀GeP₂S₁₂, Li₁₀SnP₂S₁₂, Li₁₀SiP₂S₁₂, Li_{9.54}Si_{1.74}P_{1.44}S_{11.7}Cl_{0.3}, Li_{9.6}P₃S₁₂, Li₆PS₅Cl, Li₆PS₅Br, Li₆PS₅I, Li₇P₃S₁₁, Li₃PS₄, or any combination thereof. In some aspects, the lithium-based electrolyte crystals further comprise Z.

In any of the foregoing or following aspects, a molar ratio q of the amorphous matrix to the lithium-based electrolyte crystals may be from greater than zero to 1. In some aspects, the molar ratio q is 0.1 to 1 or 0.3 to 1.

In some aspects, the compressed composite comprises Li₇P₂S₈Q₁₋ₓZₓ, where (i) Q is I, Br, Cl, F, Mg, B, N, Al, Si, Zn, Ag, Pt, or any combination thereof; (ii) Q and Z are different; (iii) the amorphous matrix comprises q(Li_{y}Z); and (iv) the lithium-based electrolyte crystals comprise Li_{7-qy}P₂S₈Q₁₋ₓZ_{x-q}, where q≤x≤1. In certain aspects, Z comprises I and y=1. In some implementations, Z comprises I, Q is Br, q=0.3 to 1, the compressed composite comprises Li₇P₂S₈Br₁₋ₓIₓ, and the lithium-based electrolyte crystals comprise Li_{7-q}P₂S₈Br₁₋ₓI_{x-q}, where q≤x≤1.

In an independent aspect, the amorphous matrix comprises q(Li_{y}Z), the amorphous matrix comprises q(Li_{y}Z), q=0.3 to 1, and the lithium-based electrolyte crystals comprise Li₇La₃Zr₂O₁₂.

In some aspects, a solid-state battery includes (i) a cathode, (ii) an anode, an anode current collector, or an anode and an anode current collector, and (iii) a solid electrolyte as disclosed herein. In some implementations, the surface portion of the compressed composite is oriented toward the anode or anode current collector.

A method for making a solid electrolyte as disclosed herein may include (i) forming a mixture by combining stoichiometric amounts of one or more lithium-based electrolyte precursors and a compound comprising Z; (ii) milling the mixture for a first period of time to form a powder; (iii) heating the powder at a temperature of from 20° C to 260° C under an inert atmosphere for a second period of time to form a composite comprising the amorphous matrix and the lithium-based electrolyte crystals at least partially embedded in the amorphous matrix; and (iv) compressing the composite under a pressure ≥450 MPa for at least one minute to form the compressed composite. In some aspects, the one or more lithium-based electrolyte precursors comprise (i) Li₂S and P₂S₅, or (ii) Li₇La₃Zr₂O₁₂.

The foregoing and other objects, features, and advantages of the disclosed technology will become more apparent from the following detailed description, which proceeds with reference to the accompanying figures.

### BRIEF DESCRIPTION OF THE DRAWINGS

FIGS. 1A-1C are schematic diagrams illustrating formation of an interfacial phase by compression (FIG. 1A), formation of an interfacial phase during a charge and discharge process (FIG. 1B), and retention of an interfacial phase during a charge and discharge process (FIG. 1C).

FIGS. 2A and 2B are schematic diagrams of a solid-state battery in a fully discharged anode-free state (FIG. 2A) and a charged state (FIG. 2B).

FIGS. 3A and 3B are XRD patterns of Li₇P₂S₈Br₁₋ₓIₓ (0≤x≤1) at 20° C, where FIG. 3B is a magnified portion 2θ of 26°-32°.

FIG. 4 is a cryo-transmission electron microscopy (cryo-TEM) image of Li₇P₂S₈Br_{0.5}I_{0.5} and selected area electron diffraction (SAED) patterns transformed from the cryo-TEM image.

FIGS. 5A and 5B show the ionic conductivities of Li₇P₂S₈Br₁₋ₓIₓ (0≤x≤1) at 20° C (FIG. 5A) and temperature-dependent ionic conductivities of Li₇P₂S₈Br_{0.5}I_{0.5} in comparison with the reported electrolytes (FIG. 5B).

FIGS. 6A-6I are scanning electron microscopy (SEM) images of Li₇P₂S₈Br₁₋ₓIₓ, wherein FIGS. 6A-6F are top view (FIGS. 6A-6C) and cross-section (FIGS. 6D-6F) images of Li₇P₂S₈Br₁₋ₓIₓ pellets (x=0, FIGS. 6A, 6D; x=0.5, FIGS. 6B, 6E; and x=1, FIGS. 6C, 6F) pressed under 625 MPa; and FIGS. 6G-6I are images of Li₇P₂S₈Br_{0.5}I_{0.5} pellets pressed under 125 MPa, 250 MPa, and 450 MPa.

FIG. 7 is an SEM image of a Li₇P₂S₈Br_{0.5}I_{0.5} pellet obtained at 625 MPa where point A was analyzed by energy dispersive spectroscopy (EDS).

FIGS. 8A and 8B show X-ray photoelectron spectroscopy of I 3d for Li₇P₂S₈Br_{0.5}I_{0.5} pellet pressed under 625 MPa (FIG. 8A); and XRD patterns of Li₇P₂S₈Br_{0.5}I_{0.5} powders before and after pressing under 625 MPa (FIG. 8B).

FIG. 9 is a graph showing the elastic modulus of lithium halides, Li₂S, and P₂S₅.

FIGS. 10A-10D are Nyquist plots of Li/Li₇P₂S₈Br/Li (FIG. 10A), Li/Li₇P₂S₈Br_{0.5}I_{0.5}/Li (FIG. 10B), and Li/Li₇P₂S₈I/Li cell (FIG. 10C) with equivalent circuit fitting (FIG. 10A) at 20° C; FIG. 10D shows the evolution of areal interfacial resistance of each cell over time at 20° C.

FIGS. 11A and 11B are Nyquist plots of Li/Li₇P₂S₈Br_{0.5}I_{0.5}/Li cell as a function of time at 60° C (FIG. 11A) and 100° C (FIG. 11B).

FIGS. 12A-12F show galvanostatic cycling of Li—Li cells at step-increased current densities at 20° C with Li₇P₂S₈Br₁₋ₓIₓ electrolytes, where x=0 (FIG. 12A), x=0.2 (FIG. 12B), x=0.5 (FIG. 12C), x=0.8 (FIG. 12D), and x=1 (FIG. 12E); FIG. 12F is a plot of critical current density vs. the value of x.

FIGS. 13A and 13B show galvanostatic cycling of the Li/Li₇P₂S₈Br_{0.5}I_{0.5}/Li cell at step-increased current densities at 60° C (FIG. 13A) and 100° C (FIG. 13B).

FIGS. 14A-14F show effects of cycling Li/Li₇P₂S₈Br₁₋ₓIₓ/Cu cells (x=0, 0.5, 1); FIGS. 14A-14C are voltage profiles of the Li/Li₇P₂S₈Br₁₋ₓIₓ/Cu cells (x=0, 0.5, 1, respectively) cycled at a current density of 0.2 mA/cm² and capacity of 2 mAh/cm²; and FIGS. 14D-14F are SEM images and the corresponding elemental mappings at the interface Li₇P₂S₈Br/Li at the Cu side (FIG. 14D), Li₇P₂S₈Br_{0.5}I_{0.5}/Li at the Cu side (FIG. 14E), and Li₇P₂S₈I/Li at the Cu side (FIG. 14F).

FIG. 15 is an SEM image and the corresponding elemental mappings of the top view of Li₇P₂S₈Br_{0.5}I_{0.5} (facing Li side) at the end of first charging.

FIGS. 16A-16C show long term cycling of a Li/Li₇P₂S₈Br_{0.5}I_{0.5}/Li cell at 0.5 mA cm⁻² with a charge/discharge capacity of 0.25 mAh cm⁻² at 20° C (FIG. 16A), 1 mA/cm² with a charge/discharge capacity of 0.5 mA cm⁻² at 60° C (FIG. 16B), and 2 mA cm⁻² with a charge/discharge capacity of 1 mAh cm⁻² at 100° C (FIG. 16C).

FIGS. 17A and 17B show cycling performance (FIG. 17A) and voltage profiles (FIG. 17B) of a S/Li₇P₂S₈Br_{0.5}I_{0.5}/Li cell under 0.1 C (1C=1600 mAh g⁻¹) at 20° C.

FIG. 18 shows in situ heating XRD results of Li₇P₂S₈Br_{0.5}I_{0.5} electrolytes prepared at temperatures ranging from 23° C to 305° C.

FIG. 19 is a differential thermal analysis (DTA) curve of the amorphous Li₇P₂S₈Br_{0.5}I_{0.5} powder after mechanical milling.

FIG. 20 is XRD patterns of the glass phase (bottom), low-temperature (e.g., 160° C) Li₇P₂S₈Br_{0.5}I_{0.5} (middle), and high-temperature (e.g., 260° C) Li₇P₂S₈Br_{0.5}I_{0.5} (top).

FIG. 21 is an SEM cross-sectional image and elemental mapping of a 2Li₇La₃Zr₂O₁₂-0.5LiI pellet pressed under 450 MPa.

### DETAILED DESCRIPTION

Solid electrolytes have high lithium-ion transport properties, low density, and favorable mechanical properties that may have potential application in high energy and power bulk-type all solid-state lithium metal batteries. However, many solid electrolytes, including most sulfide-based solid electrolytes, are not compatible with lithium metal, which can cause severe chemical/electrochemical reactions, increased interfacial resistance, and/or short circuit the battery. Practical use of sulfide-based solid electrolytes is stunted by their narrow electrochemical window, moisture sensitivity, and interfacial instability. The sulfide solid electrolytes tend to decompose when in contact with lithium metal, resulting in non-uniform Li⁺ flux at the interface, Li dendrite growth, and cell shorting.

Disclosed herein are aspects of a solid electrolyte for lithium metal batteries that overcome one or more of these deficiencies. The solid electrolyte is a composite having a unique structure comprising lithium-based electrolyte crystals at least partially embedded in an amorphous matrix comprising one or more lithiophilic elements. After compression at a pressure ≥450 MPa, or after being cycled in a battery, a surface portion of the composite has a greater concentration of the lithiophilic element(s) than an average concentration of the lithiophilic element(s) within a bulk portion of the composite.

In some aspects, the solid electrolyte is capable of high performance in a lithium metal battery by providing interfacial stability, superior lithium-ion conductivity (e.g., >4 mS/cm), ultra-low areal resistance (e.g., <5 Ωcm²) at room temperature, and low resistance (e.g., <1 Ωcm²) at elevated temperature (e.g., >50° C) against lithium metal. In certain aspects, the electrolyte provides stable cycling for more than 1,000 hours in Li/Li cells cycling under both high current density (e.g., 2 mA cm⁻²) and areal capacity (e.g., 1 mAh cm⁻²) and/or stable cycling for more than 250 cycles in an all-solid-state Li—S cell. In one example, the solid electrolyte provided a Li plating critical current density of 1.4 and 3.7 mA/cm² at 20° C and 100° C, respectively. Advantageously, the unique structure of the solid electrolyte mitigates continuous side reactions at the interface between the electrolyte and anode. In some aspects, the solid electrolyte forms a stable solid electrolyte interphase (SEI) that promotes Li nucleation along the interface, thereby ensuring compact/dense Li plating, lowering the contact resistance, and/or avoiding gap formation or delamination at the interface. Additionally, the increased concentration of the lithiophilic elements in the surface portion of the solid electrolyte are replenished as needed from the bulk portion of the electrolyte as the battery is cycled, enhancing stable cycling.

### I. Definitions

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing aspects from discussed prior art, the aspect numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0).

In order to facilitate review of the various aspects of the disclosure, the following explanations of specific terms are provided:

Alloy: A solid or liquid mixture of two or more metals, or of one or more metals with certain nonmetallic elements.

Amorphous: Non-crystalline, having no or substantially no molecular lattice structure.

Anode: An electrode through which electric charge flows into a polarized electrical device. From an electrochemical point of view, negatively-charged anions move toward the anode and/or positively-charged cations move away from it to balance the electrons leaving via external circuitry. In a discharging battery or galvanic cell, the anode is the negative terminal where electrons flow out. If the anode is composed of a metal, electrons that it gives up to the external circuit are accompanied by metal cations moving away from the electrode and into the electrolyte. When the battery is recharged, the anode becomes the positive terminal where electrons flow in and metal cations are reduced.

Areal capacity: A term that refers to capacity per unit of area of the electrode (or active material). Areal capacity, or specific areal capacity, may be expressed in units of mAh cm⁻².

Cathode: An electrode through which electric charge flows out of a polarized electrical device. From an electrochemical point of view, positively charged cations invariably move toward the cathode and/or negatively charged anions move away from it to balance the electrons arriving from external circuitry. In a discharging battery or galvanic cell, the cathode is the positive terminal, toward the direction of conventional current. This outward charge is carried internally by positive ions moving from the electrolyte to the positive cathode, where they may be reduced. When the battery is recharged, the cathode becomes the negative terminal where electrons flow out and metal atoms (or cations) are oxidized.

Ceramic: An inorganic solid, generally formed from metallic and nonmetallic elements, e.g., oxides, sulfides, phosphates.

Crystal: A solid substance having a geometrically regular form with symmetrically arranged plane faces.

Composite: A solid material composed of two or more constituent materials having different physical and/or chemical characteristics that, when combined, produce a material in which each substance retains its identity while contributing desirable properties to the whole. By “retains its identity,” it is meant that the individual materials remain separate and distinct within the composite structure. A composite is not a solid solution or a simple physical mixture of the constituent materials. In other words, each particle of the composite includes regions or domains of the two or more constituent materials.

Compressed: As used herein, the term “compressed” refers to a material formed under applied pressure. In some disclosed aspects, the term “compressed” refers to a material formed under an applied pressure ≥450 MPa.

Current collector: A battery component that conducts the flow of electrons between an electrode and a battery terminal. The current collector also may provide mechanical support for the electrode's active material.

Electrolyte: A substance containing free ions that behaves as an ionic conductive medium. Aspects of the disclosed electrolytes are solid electrolytes.

Interfacial: A boundary between two components or phases, e.g., between an electrolyte and an electrode or current collector.

Lithiophilic: Capable of forming a stable structure with lithium, e.g., an ionic compound structure or an alloy structure.

Lithium-based electrolyte: An electrolyte in which lithium ions significantly participate in electrochemical processes of electrochemical devices.

Matrix: As used herein, the term “matrix” refers to an amorphous material in which crystals are at least partially embedded.

Solid electrolyte interphase (SEI): A passivation layer generated on the anode of a battery during the first few charging cycles.

### II. Solid Electrolytes

Aspects of the disclosed solid electrolytes comprise one or more lithiophilic elements. The solid electrolyte is a composite comprising (i) an amorphous matrix comprising the lithiophilic element(s) and (ii) lithium-based electrolyte crystals (e.g., ceramic crystals) at least partially embedded in the amorphous matrix. The crystals have a different chemical composition than the amorphous matrix. In some aspects, the amorphous matrix comprises an ionic compound or an alloy, the ionic compound or the alloy having a formula of Li_{y}Z, where Z is a lithiophilic element and y is a value selected to provide the alloy or to provide the ionic compound with a neutral net charge. In some implementations, the lithiophilic elements are I, Br, Cl, F, Mg, B, N, Al, Si, Zn, Ag, Pt, or combinations thereof.

Advantageously, a surface portion of the composite comprises a concentration of Z that is greater than an average concentration of Z within a bulk portion of the composite. In some aspects, the surface portion has a thickness, or depth, from greater than 0 μm to 10 μm, such as a thickness or depth in a range having endpoints selected from 0.05 μm, 0.1 μm, 0.25 μm, 0.5 μm, 1 μm, 2 μm, 3 μm, 4 μm, 5 μm, 6 μm, 7 μm, 8 μm, 9 μm, or 10 μm, wherein the range is inclusive of the endpoints. In some aspects, the concentration of Z in the surface portion is from 0.1% to 60% greater than an average concentration of Z within the bulk portion of the composite. For example, the Z concentration in the surface portion may be increased by an amount in a range having endpoints selected from 0.1%, 0.5%, 1%, 5%, 10%, 15%, 20%, 25%, 30%, 35%, 40%, 45%, 50%, 55%, or 60% relative to the average Z concentration in the bulk portion, wherein the range is inclusive of the endpoints. The increased surface concentration may be produced by compressing the composite under a suitable pressure (e.g., ≥450 MPa) and/or by cycling a battery comprising the solid electrolyte.

After compressing electrolyte powders into a film/pellet, and/or cycling a battery comprising the solid electrolyte, the lithiophilic element(s) in a form of Li_{y}Z preferentially migrate to the electrolyte surface. Without wishing to be bound by a particular theory of operation, it currently is believed that migration occurs because the amorphous matrix is ductile, reducing solid/solid contact resistance, and can migrate when driven by applied pressure. The migrating Li_{y}Z may at least partially fill boundaries and/or voids in the surface portion of the compressed and/or cycled electrolyte. Optionally, the lithiophilic element(s), Z, preferentially migrate inside the solid electrolyte towards an interface between the electrolyte and the lithium anode and may also migrate into bulk Li, driven by electrical force (e.g., cycling a battery including the solid electrolyte) or by chemical reactions and a concentration gradient (e.g., Z reacts with Li and diffuses along the interfaces between the electrolyte and the Li). The amorphous matrix migration forms an interfacial phase rich in the lithiophilic element(s) that exhibits low resistance and protects a lithium metal anode from continuous reactions with the solid electrolyte. The migration also densifies the solid electrolyte as the lithiophilic element(s) segregate to the surface of the composite and increases surface wetting, thereby improving local contact between the electrolyte and electrodes (cathode and anode). The surface portion of increased Z concentration, an interfacial phase between the solid electrolyte and the anode or anode current collector, remains as the battery is cycled, forming a stable and highly conductive SEI.

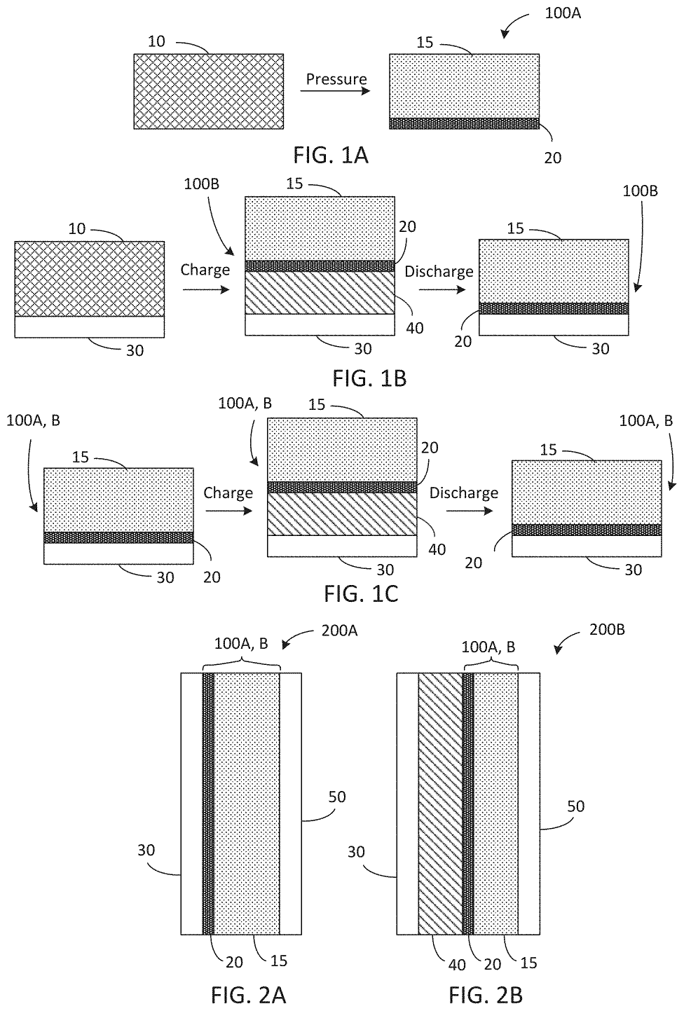

FIGS. 1A-1C are schematic diagrams illustrating the formation of a surface portion having an increased concentration of the lithiophilic element(s). In FIG. 1A, an initial solid electrolyte is a composite 10 comprising an amorphous matrix and lithium-based electrolyte crystals at least partially embedded within the amorphous matrix. Pressure is applied to the composite 10. During compression, the amorphous matrix comprising the lithiophilic element(s) preferentially migrates to a surface of the composite forming a compressed composite 100A having a surface portion 20 with an increased concentration of the lithiophilic element(s) relative to an average concentration of the lithiophilic element(s) within a bulk portion 15 of the compressed composite 100A. In FIG. 1B, the composite 10 is positioned on an anode current collector 30 and placed into a cell (not shown). Upon charging, the amorphous matrix comprising the lithiophilic element(s) preferentially migrates to a surface of the composite (i.e., the surface facing the anode current collector 30), forming a cycled composite 100B having a surface portion 20 with an increased concentration of the lithiophilic element(s) relative to an average concentration of the lithiophilic element(s) within a bulk portion 15 of the cycled composite 100B. A lithium anode 40 also forms on the anode current collector 30. Upon complete discharge, the lithium anode 40 may be fully consumed, while the cycled composite 100B retains its structure. FIG. 1C illustrates that the compressed or cycled composite 100A,B retains its structure during additional charging/discharging processes. In some aspects according to FIGS. 1B and 1C, a lithium anode may be present prior to charging and/or at least some of the lithium anode may remain after discharge (not shown).

Aspects of the disclosed electrolytes have a unique structure of crystals at least partially embedded within an amorphous matrix, wherein the crystals have a different chemical formula than the matrix. The amorphous matrix comprises lithium and a lithiophilic element. In some aspects, the amorphous matrix comprises an ionic compound or an alloy, the ionic compound or the alloy having a formula of Li_{y}Z, where Z is I, Br, Cl, F, Mg, B, N, Al, Si, Zn, Ag, Pt, or any combination thereof, and y is a value selected to provide the alloy or to provide the ionic compound with a neutral net charge. In some examples, Z is a halide (I, Br, Cl, F, or any combination thereof), y=1, and the amorphous matrix comprises LiZ. In another example, when the amorphous matrix is a lithium-boron alloy, the matrix may have a formula of Li₇B₆, which may be represented as Li_{1.17}B where y=1.17. In any of the foregoing or following aspects, the crystals may be lithium-based electrolyte crystals. Exemplary lithium-based electrolyte crystals include, but are not limited to, Li₆P₂S₈, Li₇La₃Zr₂O₁₂, Li_{1.3}Al_{0.3}Ti_{1.7}(PO₄)₃, Li₁₀GeP₂S₁₂, Li₁₀SnP₂S₁₂, Li₁₀SiP₂S₁₂, Li_{9.54}Si_{1.74}P_{1.44}S_{11.7}Cl_{0.3}, Li_{9.6}P₃S₁₂, Li₆PS₅Cl, Li₆PS₅Br, Li₆PS₅I, Li₇P₃S₁₁, Li₃PS₄, or any combination thereof. In some examples, the lithium-based electrolyte crystals comprise Li₆P₂S₈, Li₇La₃Zr₂O₁₂, or a combination thereof. In some aspects, the lithium-based electrolyte crystals further comprise Z.

In any of the foregoing or following aspects, a molar ratio q of the amorphous matrix to the lithium-based electrolyte crystals in the solid electrolyte is from greater than zero to 1. In some aspects, q is in a range having endpoints selected from 0.05, 0.1, 0.2, 0.3, 0.4, 0.5, 0.6, 0.7, 0.8, 0.9, or 1, inclusive of the endpoints. In some implementations, q is 0.1 to 1, such as 0.3 to 1, 0.3 to 0.7, or 0.3 to 0.5.

In some aspects, the composite has a composition Li₇P₂S₈Z, where Z is as previously defined. The composite comprises an amorphous matrix in an amount of q(Li_{y}Z), and the lithium-based electrolyte crystals comprise Li_{7-qy}P₂S₈Z_{1-q}. For example, if y=1 and q=0.3, then the crystals comprise Li_{6.7}P₂S₈Z_{0.7} and the amorphous matrix comprises 0.3 (LiZ). In another example, if y=1.17 and q=0.4, then the crystals comprise Li_{6.53}P₂S₈Z_{0.6} (exemplary calculation: 7−qy=7 −[0.4×1.17]=6.53) and the amorphous matrix comprises 0.4 (Li_{1.17}Z).

In some implementations, the overall composite composition may be described as having a formula Li₇P₂S₈Q₁₋ₓZₓ, where 0≤x≤1, Z and Q are different, and each of Z and Q independently is I, Br, Cl, F, Mg, B, N, Al, Si, Zn, Ag, Pt, or any combination thereof. In such implementations, the amorphous matrix has a composition q(Li_{y}Z), the lithium-based electrolyte crystals comprise Li_{7-qy}P₂S₈Q₁₋ₓZ_{x-q}, and q≤x≤1. As one example, if x=1, then element Q is absent and the formula is as previously described (e.g., Li₇P₂S₈Z). In another example, if x=q, then all of element Z is present in the amorphous matrix and the lithium-based electrolyte crystals are devoid of Z. In this example, the amorphous matrix has a composition q(Li_{y}Z) and the lithium-based electrolyte crystals comprise Li_{7-qy}P₂S₈Q₁₋ₓ. In another example, if 0 <x<1, then the crystals comprise both Q and Z. In some examples, each of Q and Z is a single element. In some aspects, x=0.1-0.9, such as 0.3-0.7 or 0.4-0.6.

In some aspects, the composite has a formula Li₇P₂S₈Q₁₋ₓZₓ, where Z is I and y=1. The amorphous matrix comprises qLiI and the crystals comprise Li_{7-q}P₂S₈Q₁₋ₓI_{x-q} where 0<q≤1 and q≤x≤1. In certain implementations, Q is Br, the amorphous matrix comprises qLiI and the crystals comprise Li_{7-q}P₂S₈Br₁₋ₓI_{x-q}. In some examples, q is 0.3 to 1. In certain examples, x=0.35 to 0.7. In one non-limiting example, the composite has a formula Li₇P₂S₈Br_{0.5}I_{0.5}. In this example, since x=0.5, then 0 <q≤0.5. For example, q may be 0.1 to 0.5 or 0.3 to 0.5. In another non-limiting example, the composite has a formula Li₇P₂S₈Br_{0.35}I_{0.65}. Because x=0.65, 0<q≤0.65. For example, q may be 0.1 to 0.65 or 0.3 to 0.65.

In some aspects, the lithium-based electrolyte crystals comprise Li₇La₃Zr₂O₁₂ and the amorphous matrix comprises q(Li_{y}Z), where q, y, and Z are as previously defined. In certain aspects, q=0.3 to 1. The overall composite may be represented as Li₇La₃Zr₂O₁₂-q(Li_{y}Z) or Li_{7+qy}La₃Zr₂O₁₂Z_{q}.

The unique structure of the disclosed solid electrolytes can provide a number of advantages. For example, the amorphous matrix densifies the solid electrolyte, enhancing Li⁺ transport across grain boundaries. The amorphous matrix migration, which forms a surface portion with a higher concentration of the lithiophilic element(s) compared to the bulk portion of the electrolyte, provides a stable and highly conductive SEI when in contact with Li metal.

In some aspects, the increased surface concentration of lithiophilic element(s) lowers the energy barrier for Li nucleation and promotes uniform Li plating. Lithiophilic element(s) in the surface portion migrate along lithium deposition frontiers, facilitating Li atom mass transfer for dense bulk Li plating as the battery is charged. The amorphous matrix is stable against lithium metal, enhances deep lithium cycling stability, and/or increases the critical current density of a cell including the solid electrolyte. The increased concentration of lithiophilic element(s) remains in the surface portion of the solid electrolyte in the SEI/Li interface even as the battery is discharged, and facilitates the next cycle of Li plating.

Advantageously, some implementations of the disclosed solid electrolytes exhibit high ionic conductivity, with the amorphous matrix being an effective lithium ion conductor. For example, LiI has a high intrinsic ionic conductivity of 10⁻⁵ mS cm⁻¹ at 25° C. In some aspects, the solid electrolyte has a high ionic conductivity (i.e., ≥4 mS/cm) at room temperature, such as an ionic conductivity of 4 mS/cm to 7 mS/cm or 4 mS/cm to 6 mS/cm at room temperature. In one example, a Li₇P₂S₈Br_{0.5}I_{0.5} electrolyte exhibited an ionic conductivity of 5.9 mS/cm at 20° C.

In certain aspects, the solid electrolyte exhibits a low areal resistance (i.e., <5 Ω cm²) against lithium at room temperature, and/or ultra-low resistance against lithium metal at elevated temperatures (e.g., >50° C). For example, the solid electrolyte may exhibit an areal resistance of 0.5 Ω cm² to 4.5 Ω cm², such as 0.5 to 3, 0.5 to 2 or 0.5 to 1.5 Ω cm² at room temperature, and/or an areal resistance of 0.5 to 3, 0.5 to 2, or 0.5 to 1 Ω cm² at temperatures >50° C. In some examples, the solid electrolyte exhibited a resistance of 1.09 Ω cm² at 20° C, 0.78 Ω cm² at 60° C and 0.15 Ω cm² at 100° C. Advantageously, the generated interfacial layer, or surface portion, is effective in protecting the lithium metal within a wide temperature range, such as a range of 20° C to 100° C.

Some implementations of the disclosed solid electrolytes enhance the critical current density of a cell including the electrolyte. In some implementations, the critical current density is from 1 mA cm⁻² to 2 mA cm⁻² at 20° C and from 3 mA cm⁻² to 5 mA cm⁻² at increased temperature, such as at 60° C to100° C. Additionally, aspects of the disclosed solid electrolytes provide long-term cycling stability of a lithium cell. In one example, a Li/Li₇P₂S₈Br_{0.5}I_{0.5}/Li cell exhibited a critical current density of 1.4 mA cm⁻² at 20° C and 3.7 mA cm⁻² at 100° C. The cell also exhibited stable cycling for more than 1,000 hours under high current density (2 mA cm⁻²) and high areal capacity (1 mAh cm⁻²), and demonstrated a high reversible specific capacity of 1440 mAh g⁻¹ after 200 cycles at 20° C. In some implementations, the solid electrolytes provide stable cycling for more than 250 cycles in an all-solid-state Li—S cell.

### III. Method of Making the Solid Electrolyte

An exemplary method for making the disclosed solid electrolytes includes (i) forming a mixture by combining stoichiometric amounts of one or more lithium-based electrolyte precursors and a compound comprising Z, (ii) milling the mixture for a first period of time to form a powder, and (iii) heating the powder at a temperature of from 20° C to 260° C under an inert atmosphere for a second period of time to form a composite comprising an amorphous matrix and lithium-based electrolyte crystals at least partially embedded in the amorphous matrix. In some aspects, the method further comprises compressing the composite under a pressure ≥450 MPa to form a compressed composite.

In some aspects, the lithium-based electrolyte precursors comprise (i) a mixture of Li₂S and P₂S₅, or (ii) Li₇La₃Zr₂O₁₂. The compound comprising Z may be any compound compatible with the electrolyte precursors, the anode material, and the cathode material. In some aspects, the compound comprising Z is a lithium salt of Z or an alloy comprising Li and Z. For example, if Z is a halide, the compound comprising Z may be LiZ.

In some implementations, the composite comprises Li₇P₂S₈Q₁₋ₓZₓ, where Q and Z independently are I, Br, Cl, or F, 0≤x≤1, and forming the mixture comprises combining stoichiometric amounts of Li₂S, P₂S₅, LiZ and LiQ. In certain implementations, Z is I, Q is Br, and x is defined as 0.5≤x≤1, and combining stoichiometric amounts of Li₂S, P₂S₅, LiZ, and LiZ comprises combining 3 parts Li₂S, 1 part P₂S₅, x parts LiI, and 1-x parts LiBr.

In any of the foregoing or following aspects, milling the mixture for the first period of time to form a powder may comprise ball milling the mixture. In some examples, ball milling is performed at a speed of 500-700 rpm for the first period of time. The first period of time may depend, in part, on the particle sizes of the lithium-based electrolyte precursors and/or the compound comprising Z. In some aspects, the first period of time ranges from 30 minutes to 75 hours, such as from 20 hours to 60 hours, or 30 hours to 50 hours. In some examples, the first period of time was 40 hours.

After milling, the powder is heated at a temperature ranging from 20° C to 260° C under an inert atmosphere for a second period of time to form a composite comprising an amorphous matrix and lithium-based electrolyte crystals at least partially embedded in the amorphous matrix. In some aspects, the temperature ranges from 50° C to 200° C, such as 75° C to 175° C, or 100° C to 160° C. The second period of time may be from 15 minutes to 5 hours, such as from 30 minutes to 2 hours, or from 30 minutes to 90 minutes. In some examples, the temperature was 160° C and the second period of time was 1 hour. The inert atmosphere may be argon, nitrogen, helium, or a combination thereof. In some examples, the inert atmosphere comprises argon.

In some implementations, the composite subsequently is compressed to form a compressed composite. The composite is compressed under a pressure ≥450 MPa. In some aspects, the pressure ranges from 450 MPa to 1000 MPa, such as a pressure in a range having endpoints selected from 450 MPa, 475 MPa, 500 MPa, 550 MPa, 600 MPa, 650 MPa, 700 MPa, or 750 MPa, wherein the range is inclusive of the endpoints. In some examples, the pressure is range of from 450 MPa to 750 MPa or 450 MPa to 650 MPa. In some implementations, the pressure is applied for at least one minute, such as a time of from 1 to 30 minutes. In certain examples, the pressure is applied for a time of from 5 to 30 minutes. As the composite is compressed, the amorphous matrix comprising the lithiophilic element(s) migrates to a surface portion of the compressed composite as previously described, such that the surface portion of the compressed composite has a greater concentration of the lithiophilic element(s) than a bulk portion of the compressed composite. In some aspects, Li_{y}Z migrates to the surface portion and at least partially fills boundaries and/or voids in the surface portion.

In other aspects, the composite need not be compressed under a pressure sufficient to induce migration of the lithiophilic element(s), but instead can be subjected to cycling to induce migration of the lithiophilic element(s). In such aspects, the composite is put into a cell and the cell is cycled. As the cell is charged, the amorphous matrix comprising the lithiophilic element(s) preferentially migrates to an interfacial region between the electrolyte and the anode, forming a cycled composite in which a surface portion of the cycled composite has a greater concentration of the lithiophilic element(s) than a bulk portion of the cycled composite.

### IV. Solid-State Batteries

A solid-state battery according to the present disclosure comprises a solid electrolyte as disclosed herein; a cathode; and either (i) an anode or an anode current collector, or (ii) an anode and an anode current collector. FIG. 2A shows a fully discharged battery 200A comprising an anode current collector 30, a cathode 50, and a compressed or cycled solid electrolyte 100A,B having a surface portion 20 with an increased concentration of the lithiophilic element(s) relative to an average concentration of the lithiophilic element(s) within a bulk portion 15 of the composite. FIG. 2B shows a partially or fully charged battery 200B, wherein the battery further comprises a lithium anode 40. The lithium anode 40 may be formed as the battery is charged. As shown in FIGS. 2A and 2B, the surface portion 20 of the electrolyte 100A,B, with its increased concentration of Z, is oriented toward the anode current collector 30 or anode 40. If the solid electrolyte is a compressed composite 100A, the battery is assembled with the surface portion 20 oriented toward the anode current collector 30 or anode 40. If the composite is not compressed prior to battery assembly, the composite structure 100B comprising the surface portion 20 and the bulk portion 150 forms as the battery is cycled. In some aspects, a lithium anode may be present in a discharged battery prior to charging and/or at least some of the lithium anode may remain after discharge (not shown). In such implementations, the anode thickness increases when the battery is charged and decreases when the battery is discharged, but the anode is not fully consumed in the discharging process.

The current collector may be any current collector suitable for a lithium-based battery. In some aspects, the current collector comprises, Al, Cu, Ni, Ti, stainless steel, or a carbon-based material. In certain aspects, the current collector is a foil, a mesh, or a foam.

The anode may be any anode suitable for a lithium-based battery. Exemplary anodes for lithium batteries include, but are not limited to, lithium metal, a lithium-metal alloy (for example, a lithium-metal alloy with Li atomic percentage of 0.1-99.9%, carbon-based anodes (e.g., graphite), silicon-based anodes (e.g., porous silicon, carbon-coated porous silicon, carbon/silicon carbide-coated porous silicon), Mo₆S₈, TiO₂, V₂O₅, Li₄Mn₅O₁₂, Li₄Ti₅O₁₂, C/S composites, and polyacrylonitrile (PAN)—sulfur composites. In some examples, the anode is lithium metal, a lithium metal alloy (e.g., Li—Mg, Li—Al, Li—In, Li—Zn, Li—Sn, Li—Au, Li—Ag), graphite, an intercalation material, or a conversion compound. The intercalation material or conversion compound may be deposited onto a substrate (e.g., a current collector) or provided as a free-standing film, typically, including one or more binders and/or conductive additives. Suitable binders include, but are not limited to, polyvinyl alcohol, polyvinyl chloride, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, epoxy resin, nylon, polyimide and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives). In some aspects, the anode is lithium metal.

In some aspects, the battery, in a fully discharged state, is anode free (e.g., as shown in FIG. 2A). In such implementations, the fully discharged battery 200A includes a current collector 30, but no anode. Instead, the anode is formed in-situ during charging. For example, as the battery is charged, lithium metal is deposited onto the current collector 30, forming an anode 40, as shown in FIG. 2B. As the battery discharges, the anode 40 may be fully consumed to return to the configuration of FIG. 2A, or the anode may be partially consumed such that at least a portion of the anode remains in the discharged state.

The cathode is any cathode suitable for use in an all-solid state lithium battery. Illustrative cathode materials include intercalated lithium, a metal oxide (for example, a lithium-containing oxide such as a lithium cobalt oxide, a lithium iron phosphate, a lithium magnesium oxide, a lithium nickel manganese cobalt oxide, or a lithium nickel cobalt aluminum oxide), or graphene. In any of the foregoing or following aspects, the cathode may further comprise one or more inactive materials, such as binders and/or additives. In some implementations, the cathode may comprise from 0-10 wt %, such as 2-5 wt % inactive materials. Suitable binders include, but are not limited to, polyvinyl alcohol, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, epoxy resin, nylon, polyimide and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives).

### V. Representative Aspects

Certain representative aspects are exemplified in the following numbered paragraphs.

1. A solid electrolyte, comprising: a compressed composite, wherein prior to cycling, the compressed composite comprises (i) an amorphous matrix comprising an ionic compound or an alloy, the ionic compound or the alloy having a formula of Li_{y}Z, where Z is I, Br, Cl, F, Mg, B, N, Al, Si, Zn, Ag, Pt, or any combination thereof, and y is a value selected to provide the alloy or to provide the ionic compound with a neutral net charge; and (ii) lithium-based electrolyte crystals at least partially embedded in the amorphous matrix, the lithium-based electrolyte crystals having a different chemical composition than the amorphous matrix, wherein a surface portion of the compressed composite has a concentration of Z that is from 1% greater to 60% greater than an average concentration of Z within a bulk portion of the compressed composite.

2. The solid electrolyte of paragraph 1, wherein the compressed composite is formed under a pressure ≥450 MPa.

3. The solid electrolyte of paragraph 1 or paragraph 2, wherein the lithium-based electrolyte crystals comprise Li₆P₂S₈, Li₇La₃Zr₂O₁₂, Li_{1.3}Al_{0.3}Ti_{1.7}(PO₄)₃, Li₁₀GeP₂S₁₂, Li₁₀SiP₂S₁₂, Li₁₀SiP₂S₁₂, Li_{9.54}Si_{1.74}P_{1.44}S_{11.7}Cl_{0.3}, Li_{9.6}P₃S₁₂, Li₆PS₅Cl, Li₆PS₅Br, Li₆PS₅I, Li₇P₃S₁₁, Li₃PS₄, or any combination thereof.

4. The solid electrolyte of any one of paragraphs 1-3, wherein the lithium-based electrolyte crystals further comprise Z.

5. The solid electrolyte of any one of paragraphs 1-4, wherein Z is I, Br, Cl, F, or any combination thereof.

6. The solid electrolyte of any one of paragraphs 1-5, wherein a molar ratio q of the amorphous matrix to the lithium-based electrolyte crystals is from greater than zero to 1.

7. The solid electrolyte of paragraph 6, wherein q is 0.1 to 1.

8. The solid electrolyte of paragraph 6 wherein q is 0.3 to 1.

9. The solid electrolyte of any one of paragraphs 6-8, wherein the compressed composite comprises Li₇P₂S₈Q₁₋ₓZₓ, where: Q is I, Br, Cl, F, Mg, B, N, Al, Si, Zn, Ag, Pt, or any combination thereof; Q and Z are different; the amorphous matrix comprises q(Li_{y}Z); and the lithium-based electrolyte crystals comprise Li_{7-qy}P₂S₈Q₁₋ₓZ_{x-q}, where q≤x≤1.

10. The solid electrolyte of paragraph 9, wherein: Z comprises I; and y=1.

11. The solid electrolyte of paragraph 10, wherein: Q is Br; q=0.3 to 1; the compressed composite comprises Li₇P₂S₈Br₁₋ₓIₓ; and the lithium-based electrolyte crystals comprise Li_{7-q}P₂S₈Br₁₋ₓI_{x-q}, where q≤x≤1.

12. The solid electrolyte of any one of paragraphs 6-8, wherein: the amorphous matrix comprises q(Li_{y}Z); q=0.3 to 1; and the lithium-based electrolyte crystals comprise Li₇La₃Zr₂O₁₂.

13. A solid-state battery, comprising: a cathode, an anode, an anode current collector, or an anode and an anode current collector; and a solid electrolyte according to any one of paragraphs 1-12.

14. The solid-state battery of paragraph 13, wherein the surface portion of the compressed composite is oriented toward the anode or anode current collector.

15. The solid state battery of paragraph 13 or paragraph 14, wherein: the compressed composite comprises Li₇P₂S₈Br₁₋ₓIₓ; the amorphous matrix comprises qLiI; and the lithium-based electrolyte crystals have a chemical formula Li_{7-q}P₂S₈Br₁₋ₓI_{x-q}, where 0.1≤q≤1 and q≤x≤1.

16. A method for making a solid electrolyte according to any one of paragraphs 1-12, comprising: forming a mixture by combining stoichiometric amounts of one or more lithium-based electrolyte precursors and a compound comprising Z; milling the mixture for a first period of time to form a powder; heating the powder at a temperature of from 20° C to 260° C under an inert atmosphere for a second period of time to form a composite comprising the amorphous matrix and the lithium-based electrolyte crystals at least partially embedded in the amorphous matrix; and compressing the composite under a pressure ≥450 MPa for at least one minute to form the compressed composite.

17. The method of paragraph 16, wherein the one or more lithium-based electrolyte precursors comprise (i) Li₂S and P₂S₅, or (ii) Li₇La₃Zr₂O₁₂.

18. The method of paragraph 17, wherein: the compressed composite comprises Li₇P₂S₈Q₁₋ₓZₓ, where Q and Z independently are I, Br, Cl, or F, and 0≤x≤1; and forming the mixture comprises combining stoichiometric amounts of Li₂S, P₂S₅, LiZ and LiQ.

19. The method of paragraph 18, wherein: Z is I; Q is Br; 0.5≤x≤1; and combining stoichiometric amounts of Li₂S, P₂S₅, LiZ, and LiZ comprises combining 3 parts Li₂S, 1 part P₂S₅, x parts LiI, and 1-x parts LiBr.

20. The method of any one of paragraphs 16-19, wherein: (i) the temperature is from 100° C to 160° C; or (ii) the inert atmosphere comprises argon, nitrogen, helium, or a combination thereof; or (iii) the first period of time is from 20 hours to 60 hours; or (iv) the second period of time is from 30 minutes to 2 hours; or (v) any combination of (i), (ii), (iii), and (iv).

### VI. EXAMPLES

### Example 1 Synthesis and Characterization of Li₇P₂S₈Br₁₋ₓIₓ (0≤x≤1) Electrolytes

### Methods

Preparation of solid-state electrolytes. Glass-ceramic Li₇P₂S₈Br₁₋ₓIₓ (0≤x≤1) electrolytes were prepared by ball-milling followed by low-temperature heat treatment. Stoichiometric amounts of Li₂S (Sigma-Aldrich, anhydrous, 99%), P₂S₅ (Sigma-Aldrich, 99%), LiBr (Sigma-Aldrich, 99.99%), and LiI (Sigma-Aldrich, 99.99%) were hand-ground before transferring to a zirconium oxide grinding jar. The mixture was ball-milled for 40 h at a speed of 600 rpm using a planetary ball mill (RETSCH PM 100 Planetary Ball Mill). The obtained powders were heated at 160° C for 1 hour. The whole process was under argon atmosphere protection.

Characterization. Powder XRD measurements were performed on a Rigaku Miniflex II spectrometer with Cu Kα radiation, using an XRD holder with a beryllium window (Rigaku Corp.) for air sensitive samples. The morphology of the electrolyte pellets was investigated with a scanning electron microscope (JSM-IT200, JOEL).

Electrochemical measurement. The Li-ion conductivity of the SSE was measured by electrochemical impedance spectroscopy (EIS) using Biologic SP 200 over a 7 MHz to 1 Hz frequency range with an amplitude of 5 mV. An SSE pellet was prepared by pressing powders under a pressure of 450 MPa. Carbon-coated aluminum foils were attached on both faces of pellets, serving as blocking electrodes. The symmetric cell was assembled in a PEEK die sleeve with stainless steel (SS316) spacers as current collectors. A Lanher battery tester or a Biologic potentiostat (VMP3) was used for the symmetric cell cycling at different temperatures.

### Results

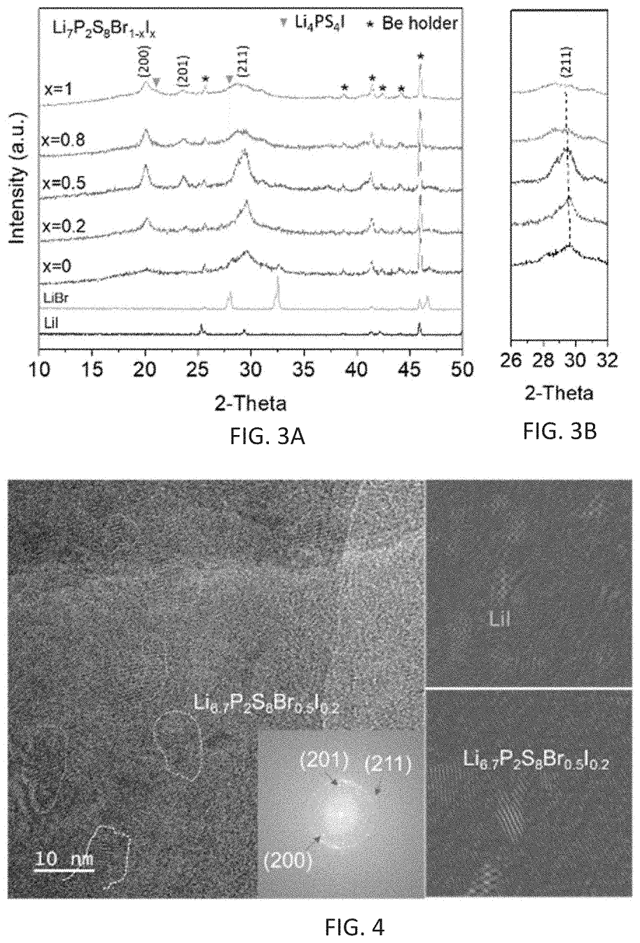

Phase and microstructure of Li₇P₂S₈Br₁₋ₓIₓ (0≤x≤1). FIG. 3A compares the powder X-ray diffraction (XRD) patterns of the Li₇P₂S₈Br₁₋ₓIₓ (0≤x≤1) by varying the amounts of the halide dopants. Diffraction peaks of beryllium (Be) from the sample holder are marked and used as an internal reference. Peaks centered at 28.2° and 32.6° are detected in Li₇P₂S₈Br (x=0) and ascribed to the unreacted LiBr. The content of LiBr was gradually decreased until the LiBr XRD peaks disappeared. The corresponding composition was Li_{6.7}P₂S₈Br_{0.7}, which was isostructural to Li₄PS₄Br. Accordingly, the Li₇P₂S₈Br is believed to be a composite of Li_{6.7}P₂S₈Br_{0.7}—(LiBr)_{0.3}. With increased LiI content in Li₇P₂S₈Br₁₋ₓIₓ, the peak at around 29.6°, corresponding to plane (211) for Li_{6.7}P₂S₈Br_{0.7}, shifted to a small angle (FIG. 3B). Considering the larger ionic radius of I⁻ (2.06 Å) versus Br⁻ (1.82 Å), this suggests that element Br⁻ was successfully substituted by I⁻ in the structure. Moreover, the intensity of LiBr peak decreased with increasing of LiI and completely disappeared after x approached 0.5. When x≥0.8, two new peaks, centered at around 21° and 31°, showed up in Li₇P₂S₈Br₁₋ₓIₓ, suggesting the formation of a Li₄PS₄I-type phase (also considered as Li₇P₂S₈I high temperature phase). No LiI peaks were detected in all XRD patterns. Without wishing to be bound by a particular theory of operation, given the phase evolutions upon incorporating LiI in Li₇P₂S₈Br₁₋ₓIₓ (0≤x≤1), part of LiI is believed to contribute to the phase formation with the rest remaining as amorphous LiI. The content of the amorphous LiI increased when x≥0.5.

To study the microstructures of the SSEs, cryo-transmission electron microscopy (cryo-TEM) was conducted on the sample Li₇P₂S₈Br_{0.5}I_{0.5}. A high-resolution TEM (HRTEM) study identified a glass-ceramic microstructure of Li₇P₂S₈Br_{0.5}I_{0.5} (FIG. 4), where the crystalline particles are embedded in an amorphous matrix. Selected area electron diffraction (SAED) patterns from Fourier transformation indicate the crystalline particles have a typical d-spacing of 0.298 nm, which is derived from (211) planes of Li_{6.7}P₂S₈Br₁₋ₓI_{x-q} where q=0.3. The outside amorphous matrix is composed of nanocrystalline LiI. This confirmed the mosaic composite structure of Li₇P₂S₈Br₁₋ₓIₓ (0≤x≤1) formed at relatively low temperature, where Li_{6.7}P₂S₈Br₁₋ₓI_{x-q} (0≤x≤0.7 and q≤x) crystals are embedded in the halide-rich amorphous phase.

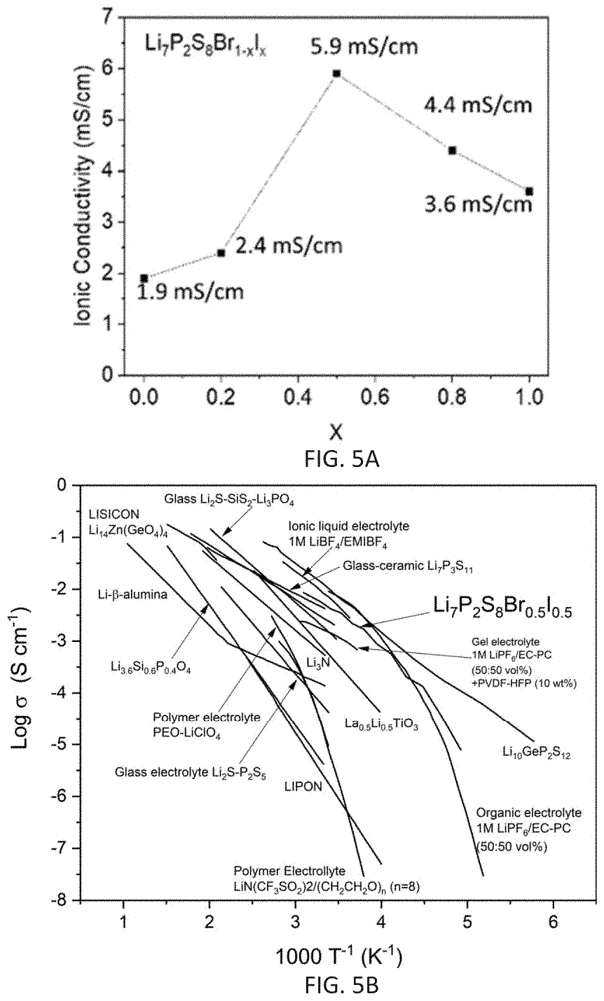

The unique mosaic structure of Li_{6.7}P₂S₈Br₁₋ₓI_{(x-0.3)}-(LiI)_{0.3} provides the SSE with high ionic conductivity. FIG. 5A shows Li⁺ conductivity of Li₇P₂S₈Br₁₋ₓIₓ (0≤x≤1) as a function of x at 20° C. Without any iodide, the Li₇P₂S₈Br (x=0) had a conductivity a of 1.9 mS cm⁻¹. With increasing iodide concentration, the ionic conductivity of Li₇P₂S₈Br₁₋ₓIₓ increased due to the formation of both the iodide substituted crystal phase and amorphous LiI. The LiI has a much higher intrinsic ionic conductivity (10⁻⁵ mS cm⁻¹ at 25° C) compared to other Li halides, oxides, and its wide distribution among the crystals forms a solid ionic conductive network, lowering solid-solid boundary resistance. The ionic conductivity reached an extremely high value of 5.9 mS cm⁻¹ at x=0.5, suggesting an optimal ratio of the crystal/amorphous ratio in the mosaic structure. Beyond the point x=0.5, a decreasing trend of σ was observed from 4.4 mS cm⁻¹ for Li₇P₂S₈Br_{0.2}I_{0.8} to 3.6 mS cm⁻¹ for Li₇P₂S₈I. Without wishing to be bound by a particular theory of operation, it is believed that the excess of I is barely doped into the conductive crystalline phase; instead, it increases the thickness of the amorphous layer and thus interfacial resistance. FIG. 5B shows the temperature-dependent ionic conductivities of the Li₇P₂S₈Br_{0.5}I_{0.5} along with other reported electrolytes, where Li₇P₂S₈Br_{0.5}I_{0.5} in a cold pressed pellet exhibited a comparable ionic conductivity with other LISICON, Li₇P₃S₁₁ and Li₁₀GeP₂S₁₂ electrolytes.

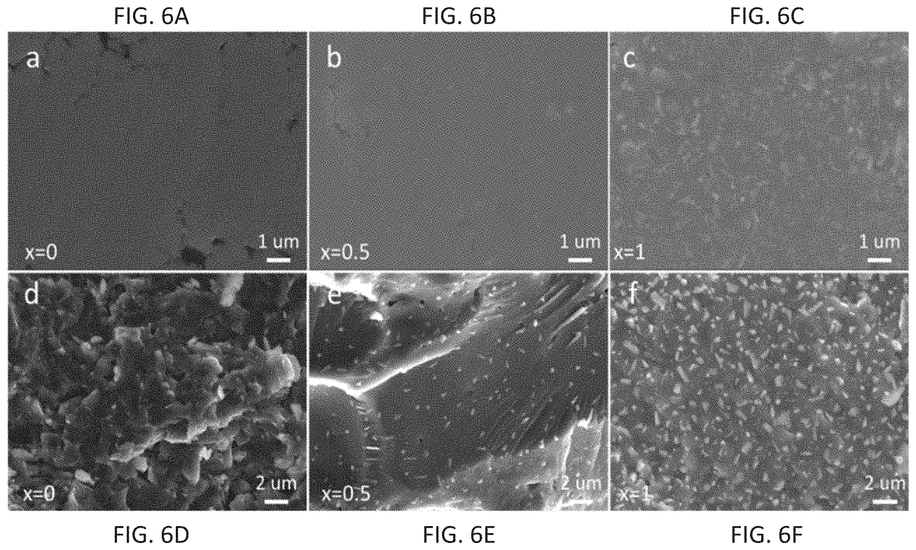

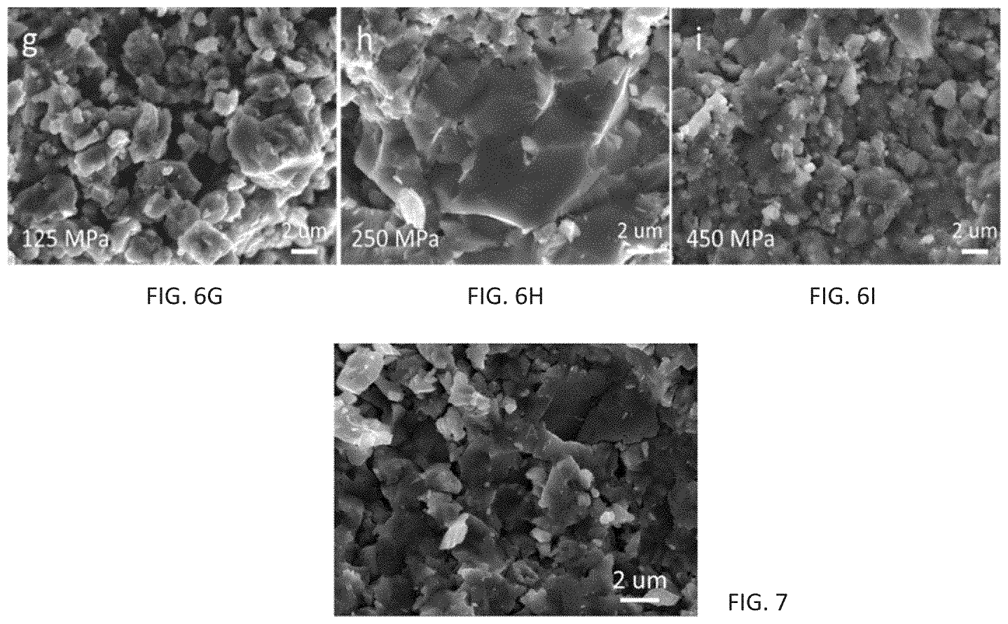

Pressure induced solid wetting of LiI. Presence of the amorphous Lil helps to densify the SSE pellet through a cold press. The effect of LiI content on pellet densification was studied on Li₇P₂S₈Br₁₋ₓIₓ (x=0, 0.5, 1) at a constant pressure of 625 MPa (FIGS. 6A-6F). Scanning electron microscopy (SEM) study revealed that with increasing LiI content, the top surface of the pellets became more compact with less stacking pores (FIGS. 6A-6C). Moreover, a second phase accumulating at grain boundaries was identified in both top view and cross-section SEM images (x=0.5 and 1; FIGS. 6B-6C, 6E-6F) and its concentration increased with LiI content. Point energy dispersive spectroscopy (EDS) analysis (FIG. 7 (point A), Table 1) showed that the new observed phase was rich in I, suggesting that amorphous LiI segregated to the grain boundaries during compaction.

TABLE 1

| Element | Line | Mass % | Atom % |
|---|---|---|---|
| S | K | 59.08 ± 5.73 | 84.01 ± 8.15 |
| Br | L | 6.12 ± 2.97 | 3.49 ± 1.70 |
| I | L | 34.80 ± 10.45 | 12.50 ± 3.73 |
| Total | | 100.00 | 100.00 |

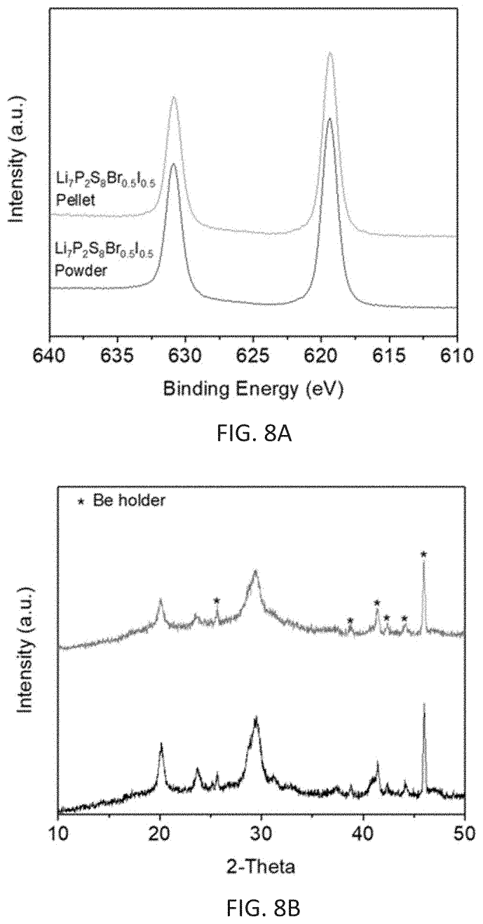

To understand how the amorphous Lil behaved during the compaction, Li₇P₂S₈Br_{0.5}I_{0.5} was selected as an example and the pellet morphology changes under different pressures (125, 250, 450, 625 MPa) were monitored (FIGS. 6G-6I and 6E). No obvious Lil segregation was detected in the pellet until the pressure increased to 625 MPa (FIG. 6E). X-ray photoelectron spectroscopy (XPS) and XRD were conducted on the Li₇P₂S₈Br_{0.5}I_{0.5} powder and pellet (625 MPa) to identify any chemical or structural evolutions upon pressing. FIG. 8A displays the high resolution I 3d XPS spectra of Li₇P₂S₈Br_{0.5}I_{0.5} from powder and pellet. For the powder, the I 3d_{5/2} component was observed at 619.3 eV, corresponding to I⁻ ions in LiI, in good agreement with previous studies (Bjelkevig et al., Electrochim Acta 2009, 54:3892-3898; Wu et al., Adv Mater 2015, 27:101-108). No apparent changes in I 3d XPS spectra were observed in pellet samples, excluding chemical changes of I⁻. XRD patterns of Li₇P₂S₈Br_{0.5}I_{0.5} powder and pellet were compared and showed no obvious changes after pelletizing the powder, indicating that the crystal phase maintained upon pressing (FIG. 8B).

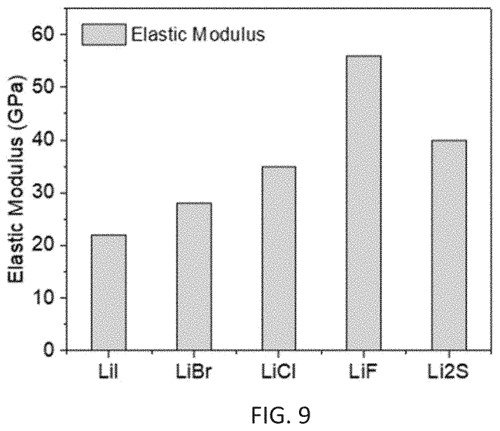

Given the SEM, XPS, and XRD results, the new morphology changes under high pressure are attributed to the evolution of amorphous LiI. LiI is ductile particularly at an amorphous state, and it tends to migrate when driven by a high pressure. FIG. 9 shows the elastic modulus of Li halides, Li₂S, and P₂S₅, where LiI displays the lowest elastic modulus or highest ductility. Thus, considering its Li+ conductive nature, the amorphous LiI functions as a Li⁺ conductive solid-wetting agent to improve both compactness and overall conductivity of the SSE pellets.

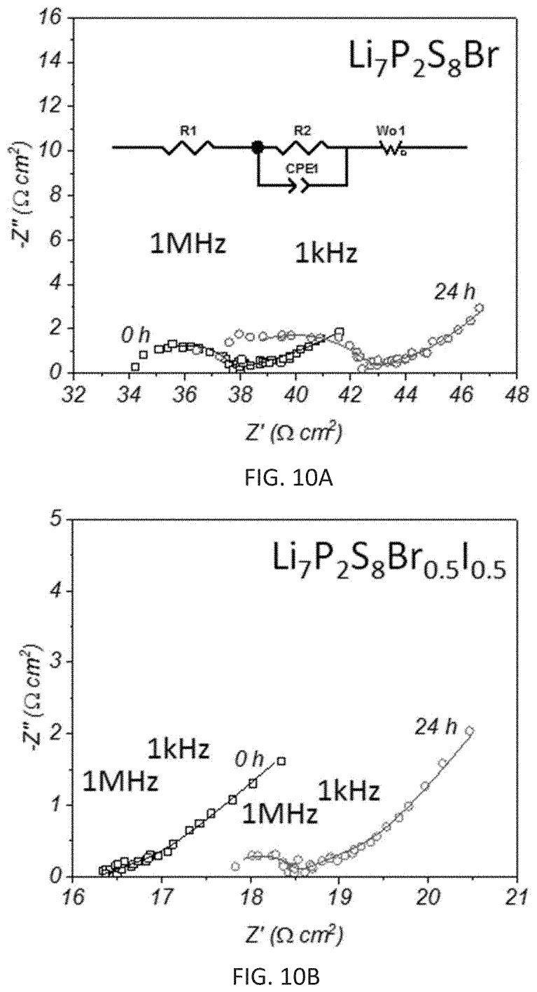

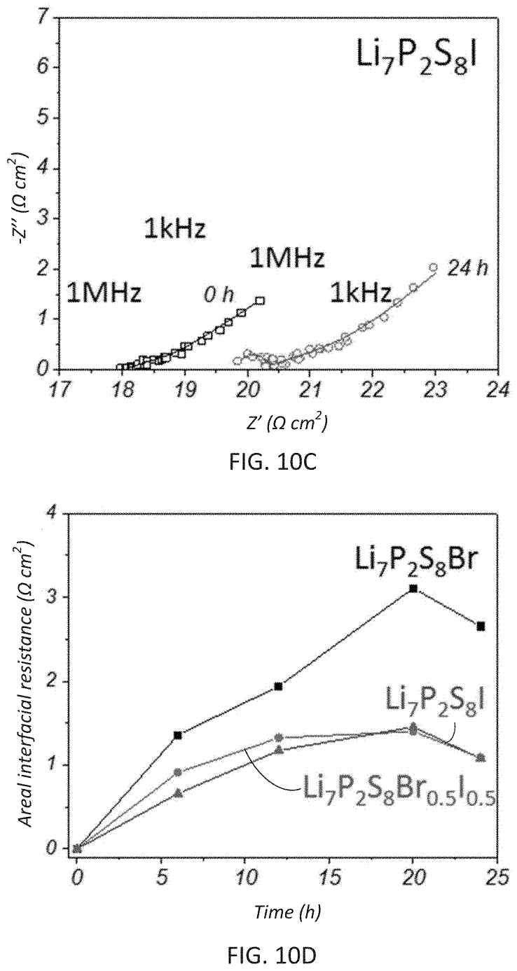

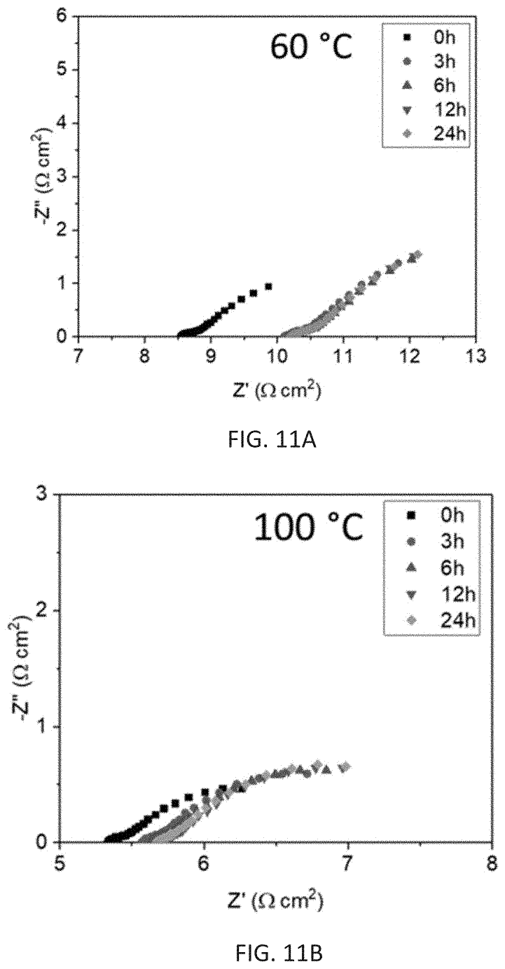

Low resistance Li₇P₂S₈Br₁₋ₓIₓ/Li interface. Impacts of amorphous LiI and its migration on Li interface were studied by monitoring the impedance evolutions of the Li/SSE/Li symmetric cells. The Nyquist plots of Li/Li cells with equivalent circuit fitting are shown in FIGS. 10A-10C. A clear semicircle was detected in the initial EIS spectra of Li₇P₂S₈Br at 20° C. It is ascribed to the grain boundary resistance of the SSE rather than interfacial resistance due to short contacting time between Li₇P₂S₈Br and Li. In contrast, no semicircle was detected for Li₇P₂S₈Br_{0.5}I_{0.5} and Li₇P₂S₈I at 0 h, suggesting a negligible grain boundary resistance, which likely is attributable to the solid-wetting agent of LiI enhancing the Li conduction. After 24 h, the overall resistance of the cell Li/Li₇P₂S₈Br/Li increased from 37.2 to 42.5 Ω cm², corresponding to the deterioration of the Li₇P₂S₈Br/Li interface. The measured interfacial resistance (AIR) of Li₇P₂S₈Br/Li was 2.65 Ω cm². The evolution of overall resistance and AIR along with time are shown in FIG. 10D. In contrast to Li₇P₂S₈Br, the AIRs of Li₇P₂S₈Br_{0.5}I_{0.5}/Li and Li₇P₂S₈I/Li after 24 h were only 1.09 and 1.08 Ω cm², respectively. Moreover, both SSEs with LiI (Li₇P₂S₈Br_{0.5}I_{0.5} and Li₇P₂S₈I) displayed an exceptionally stable and low AIR, indicating that the presence of LiI facilitates building a superior stable and highly Li⁺ conductive SEI. Chemical reactions between Li thiophosphates and Li metal are believed to be more severe at elevated temperatures, which potentially leads to quick increase of AIRs. Surprisingly, extremely low and stable AIRs of 0.78 and 0.15 Ω cm² were achieved for Li₇P₂S₈Br_{0.5}I_{0.5}/Li at 60° C and 100° C, respectively, indicating a more stable interface with lower ionic resistance was formed when the SSE contacted Li metal at elevated temperatures (FIGS. 11A-11B). Such stable SEI with low areal resistance is a key for SSEs to achieve high critical current density (CCD) in Li/Li symmetric cells.

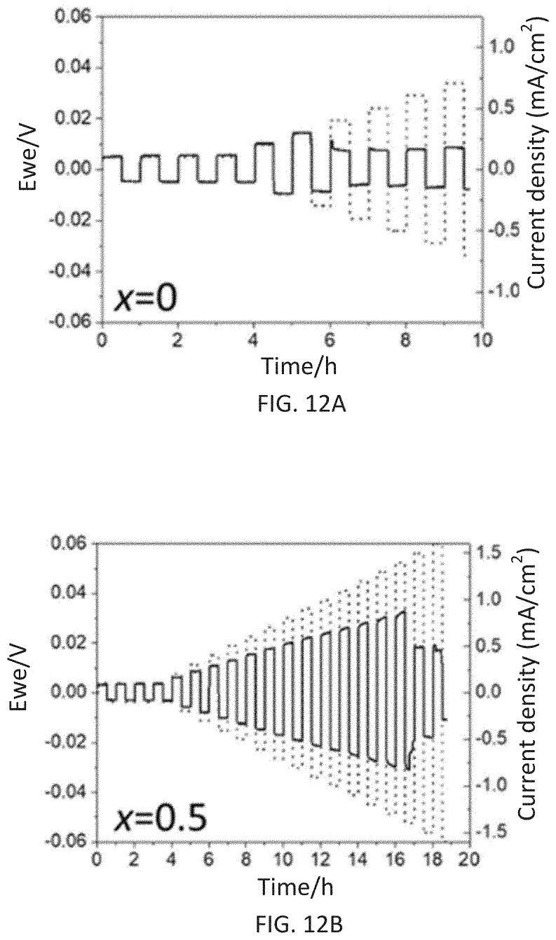

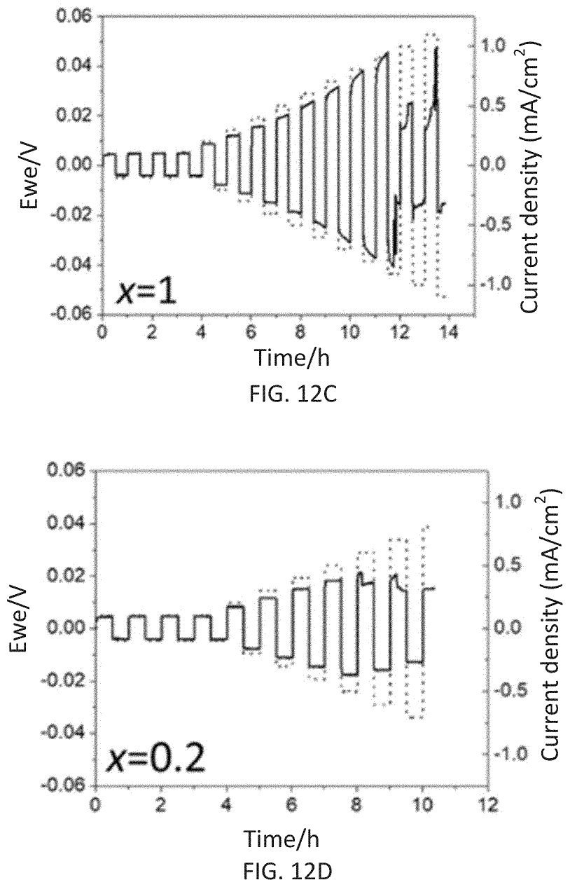

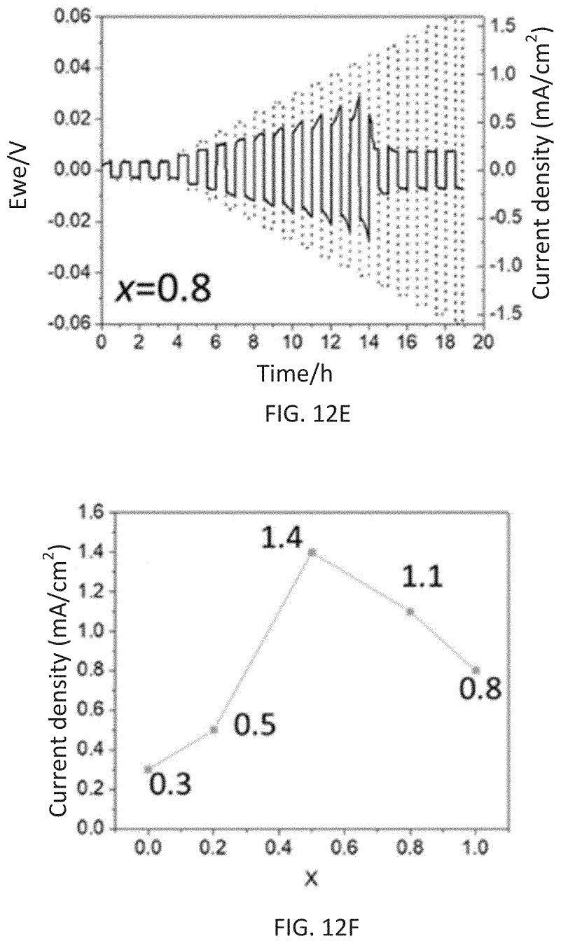

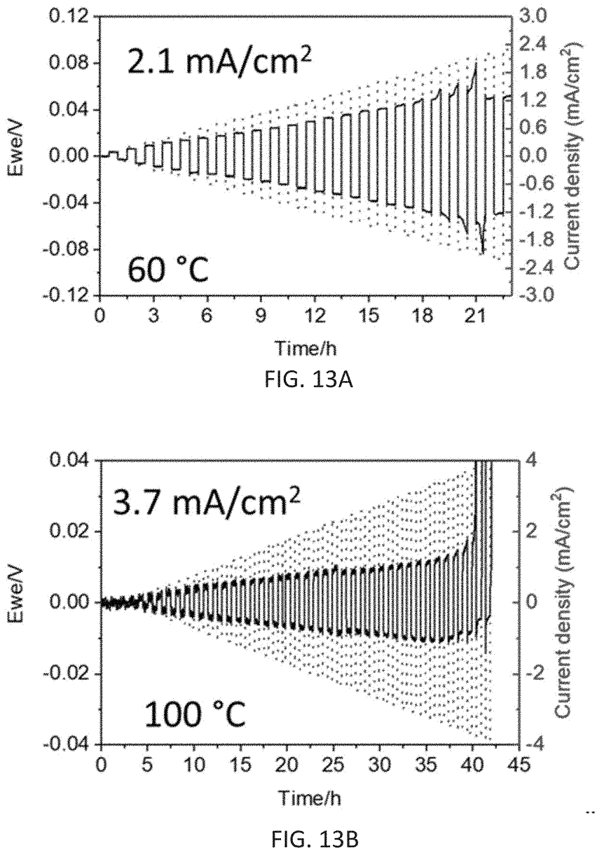

FIGS. 12A-12E show the voltage-time profiles for the Li/SSE/Li cells with Li₇P₂S₈Br₁₋ₓIₓ (0≤x≤1) electrolytes. Initially, the voltages increased with currents (step size of 0.1 mA cm⁻²) for all SSEs. After cycling for a certain amount of time, all the Li—Li cells experienced a voltage drop. The voltage drop was caused by internal short circuit as a result of Li dendrite penetration through the SSE layer. The current density after voltage dropped is regarded as CCD for the Li dendrite formation, and the magnitude of the CCD is used to evaluate the capability of dendrite suppression. The CCD of the Li₇P₂S₈Br without any LiI was determined to be 0.3 mA cm⁻². The CCD increased with LiI content, reaching the maximum value of 1.4 mA cm⁻² (corresponding to a 370% increase) at x=0.5 (Li₇P₂S₈Br_{0.5}I_{0.5}), and then decreased to 1.1 mA cm⁻² at x=0.8 and 0.8 mA cm⁻² at x=1. As high temperature operation is advantageous for ASSLBs, the effect of temperature on CCDs of Li₇P₂S₈Br_{0.5}I_{0.5} was also evaluated. FIGS. 13A and 13B Li/Li₇P₂S₈Br_{0.5}I_{0.5}/Li symmetric cell cycling at different temperatures. The CCD for Li₇P₂S₈Br_{0.5}I_{0.5} was 1.7 mA cm⁻² at 60° C and 3.7 mA cm⁻² at 100° C, which would provide decent basis for high-temperature and high-power batteries.

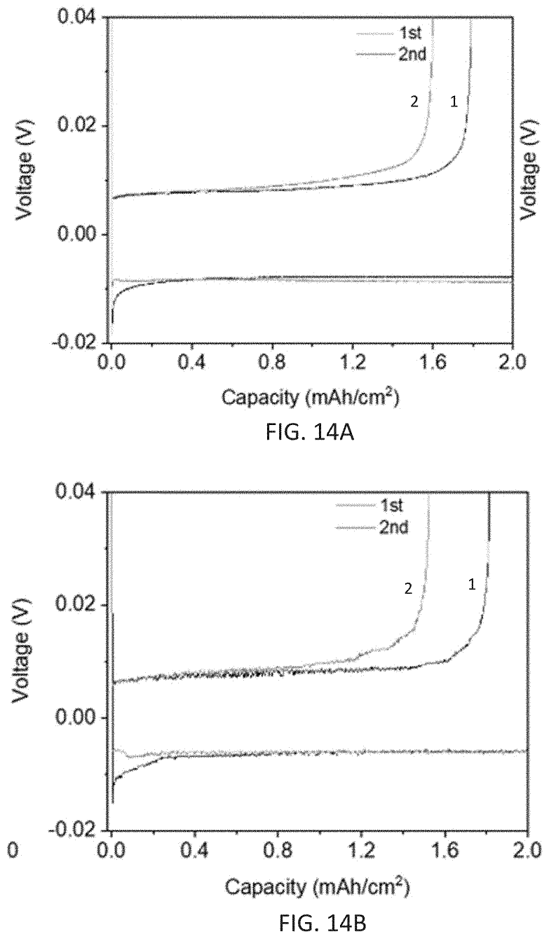

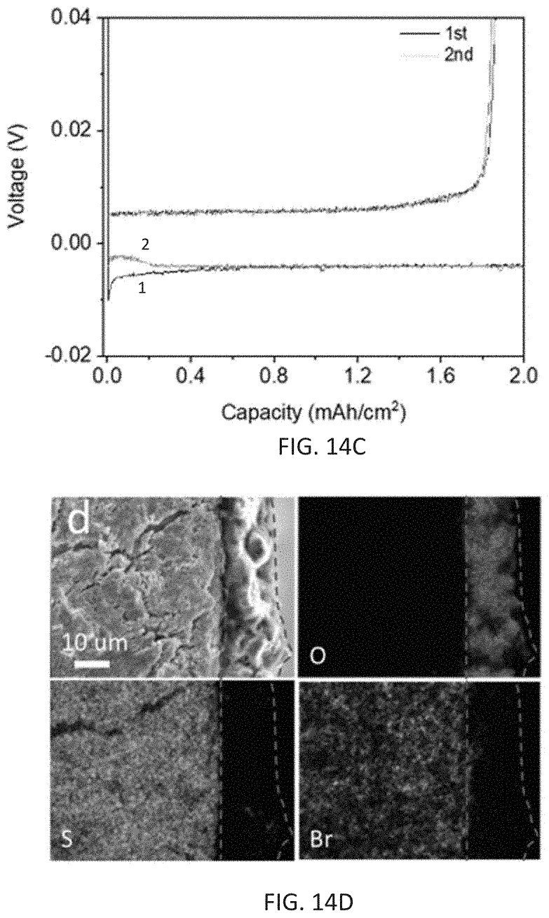

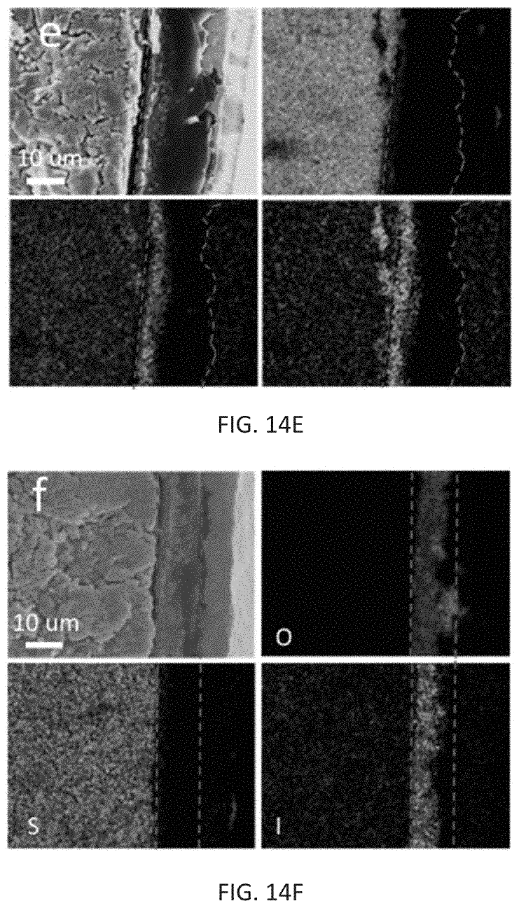

Diffusion of I⁻ to the plated Li facilitates compact Li plating. To understand how the LiI affects the Li plating/striping, Li/Li₇P₂S₈Br₁₋ₓIₓ/Cu (x=0, 0.5, 1) cells were tested with an areal capacity of 2 mAh cm⁻² (corresponding to approximately 10 μm of Li). At a current density of 0.2 mA cm⁻², the Li plating began at an overpotential of −18.5 mV, and then the voltage increased quickly to −7.7 mV and remained constant (FIG. 14A). The second plating started with an overpotential of −11.8 mV, which was higher than that for the initial plating, probably due to the Li residual serving as nucleation sites. Once the plating started, the voltage jumped to −8.1 mV before decreasing along with plating till the end at −8.75 mV, such voltage jump indicating a large Li nucleation barrier at the beginning. In contrast, the cell Li/Li₇P₂S₈Br_{0.5}I_{0.5}/Cu did not show such high overpotential for the second plating (FIG. 14B). The starting voltage (−5.6 mV) for the second plating is higher than the that for the subsequent Li bulk plating (−6.8 mV), indicating a much smaller energy barrier for Li nucleation, which may be due to the favorable SSE/Li interface. With increase of LiI content, even smaller overpotential (i.e. −4mV) and easier Li plating were observed in the Li/Li₇P₂S₈I/Cu cell (FIG. 14C). The voltage for the second plating started at −4 mV and quickly increased to −2.2 mV. This suggests the higher LiI content, the lower overpotential for Li nucleation and plating (especially after first cycle).

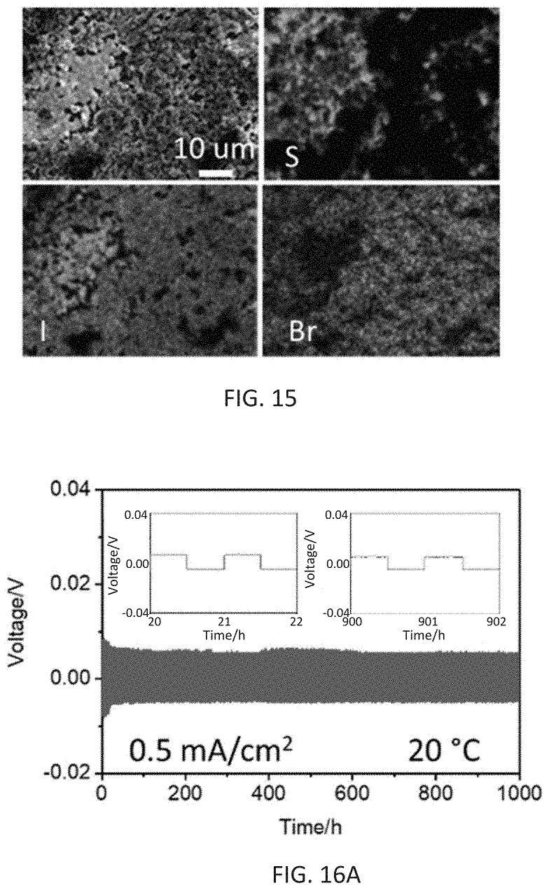

To understand Li plating behaviors, at the end of 1^{st} plating, the cells were cross-sectioned and subjected to SEM and EDS characterization. The results are presented in FIGS. 14D-14F. Oxygen (O) signal was detected on the surface of deposited Li, which is due to the short exposure of samples to the ambient environment when loading samples. Thus, O can be used as an indicator for Li metal. FIG. 14D presents the cross-sectional SEM of plated Li on the surface of Li₇P₂S₈Br. The plated Li metal was somewhat loose, suggesting void formation and accumulation and corresponding to the high polarization during the Li plating. By contrast, much denser Li plating was observed for Li₇P₂S₈Br_{0.5}I_{0.5}/Li (FIG. 14E) and Li₇P₂S₈I/Li (FIG. 14F) without obvious pore formation, which agrees well with the lower Li plating polarization. Interestingly, the migration and accumulation of I from SSE to Li surface was clearly observed at both interfaces of Li₇P₂S₈Br_{0.5}I_{0.5}/Li and Li₇P₂S₈I/Li (FIGS. 14E, 14F). Surprisingly, Br did not migrate in the Li₇P₂S₈Br/Li cell but its diffusion towards Li was detected at the Li₇P₂S₈Br_{0.5}I_{0.5}/Li cell. These results suggest that I⁻ not only has higher diffusivity than Br but also spurs the diffusion of Br⁻. Accompanying I⁻ migration to Li metal, more LiI rich SEI is expected to be formed on the interfaces of Li₇P₂S₈Br_{0.5}I_{0.5}/Li and Li₇P₂S₈I/Li during Li plating. After the subsequent stripping of Li, the LiI was released and reaccumulated at the SSE/Cu interface (FIG. 15), which will promote subsequent Li plating/stripping. Both electrochemical and morphological characterizations demonstrated that LiI can be absorbed by and released from Li reversibly, facilitating stable Li plating/stripping.

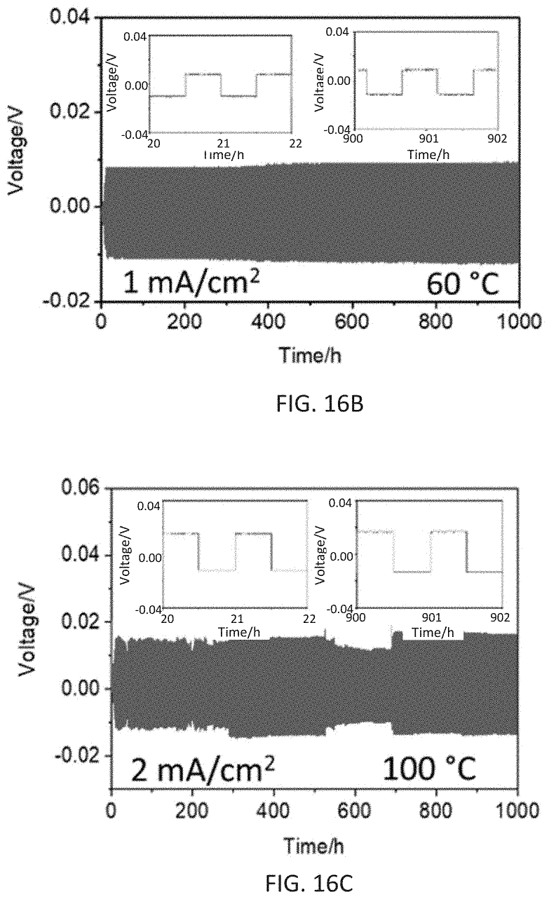

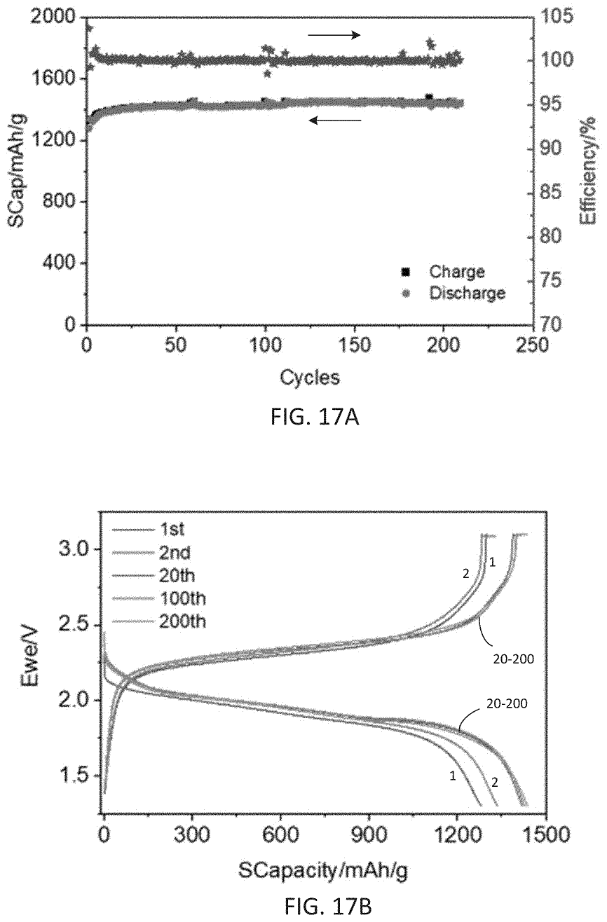

Due to the stable and low-resistance SSE/Li interface featuring a regenerative LiI-rich SEI, the Li₇P₂S₈Br_{0.5}I_{0.5} enables long-term Li cell cycling at different conditions. FIG. 16A shows the cycling performance of a Li/Li₇P₂S₈Br_{0.5}I_{0.5}/Li cell at 20° C at 0.5 mA cm⁻² with a charge/discharge capacity of 0.25 mAh cm⁻². No sign of shorting was observed throughout the cycling of 1000 h. Stable cell cycling (1000 h) was also achieved at 60° C at 1 mA cm⁻² with a charge/discharge capacity of 0.5 mAh cm⁻² (FIG. 16B) and at 100° C at 2 mA cm⁻² with a charge/discharge capacity of 1 mAh cm⁻² (FIG. 16C). Both exceptionally high ionic conductivity and outstanding dendrite suppression capability suggest Li₇P₂S₈Br_{0.5}I_{0.5} is a promising SSE for next-generation ASSLBs. To further validate the applicability of the Li₇P₂S₈Br_{0.5}I_{0.5}, it was adopted to fabricate all solid-state S/Li₇P₂S₈Br_{0.5}I_{0.5}/Li full cells. FIGS. 17A and 17B present the voltage profiles and cycling performance, respectively, of the S/Li₇P₂S₈Br_{0.5}I_{0.5}/Li under 0.1 C (1C=1600 mAh g⁻¹) at 20° C. At an areal capacity of ˜2 mAh cm⁻², the cell delivered a high reversible capacity of 1440 mAh g⁻¹ and was cycled for 250 cycles without capacity decay and short circuit, which is among the best cycling in all-solid-state sulfur batteries with pure Li as an anode.

Sulfide SSEs Li₇P₂S₈Br₁₋ₓIₓ, (0≤x≤1) have been developed with the highest ionic conductivity of 5.9 mS cm⁻¹ achieved at x=0.5 at 20° C. The obtained Li₇P₂S₈Br_{0.5}I_{0.5} exhibited exceptionally low and stable areal interfacial resistance in contacting Li metal, and the Li/Li₇P₂S₈Br_{0.5}I_{0.5}/Li symmetric cell showed a high critical current density of 3.7 mAh cm⁻² and long-term cycling stability (>1000 h) at 2 mAh cm⁻² at 100° C. Due to the great anodic stability of Li₇P₂S₈Br_{0.5}I_{0.5}, a S-KB/Li₇P₂S₈Br_{0.5}I_{0.5}/Li full cell with high areal capacity of 2 mAh cm⁻² delivered a highly reversible capacity of 1440 mAh g⁻¹ during 250 cycles. Experimental and computational studies showed that LiI plays a significant role in achieving such great electrochemical performance: First, LiI with high Li⁺ conductivity and ductility, serving as solid wetting agent, is segregated to the surface of Li₇P₂S₈Br_{0.5}I_{0.5} particles during compaction, which facilitates pellet densification, improves the local contact between SSE and Li, and enhances ionic conductivity across grain boundaries and SEI. Second, Lil helps to form a stable and highly conductive SEI. Third, I⁻ migrates along Li deposition frontiers, facilitating Li atom mass transfer for dense bulk Li plating. Most importantly, the LiI interface is reversible upon Li plating/stripping and even can be replenished from the SSE, enhancing stable Li cycling.

### Example 2

### Effect of Synthesis Temperature

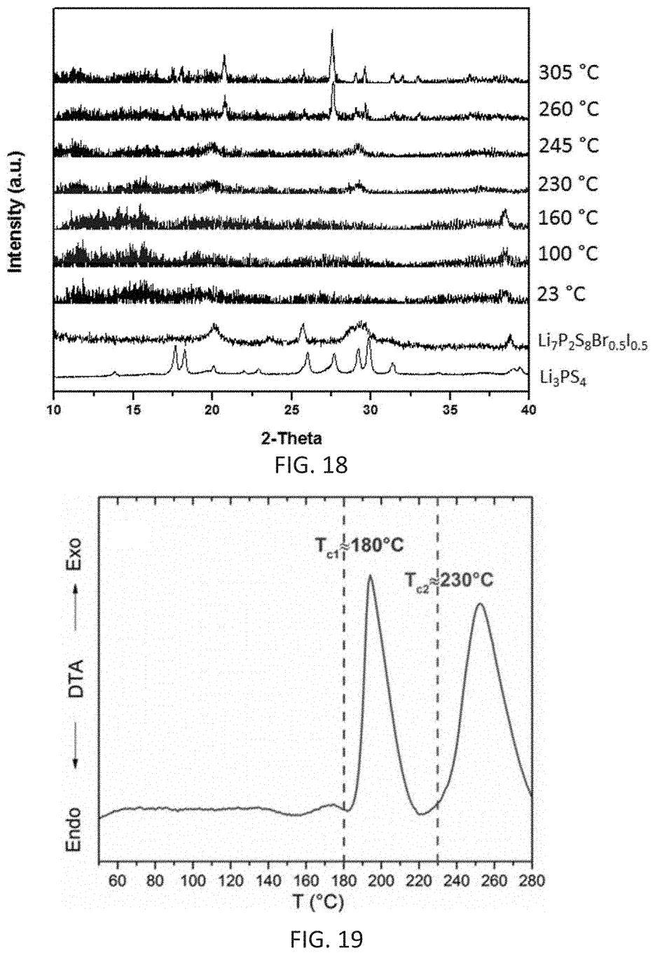

Li₇P₂S₈Br_{0.5}I_{0.5} (LPSBI) electrolytes were prepared as in Example 1, with the powders being heated at temperatures ranging from 23° C to 305° C. In situ heating XRD was performed. As shown in FIG. 18, when T>160° C, a new peak appeared. When T>260° C, Li₃PS₄ formed. The results demonstrated that temperatures from 160° C to 260° C effectively produced the high ionic conductive LiI phase.

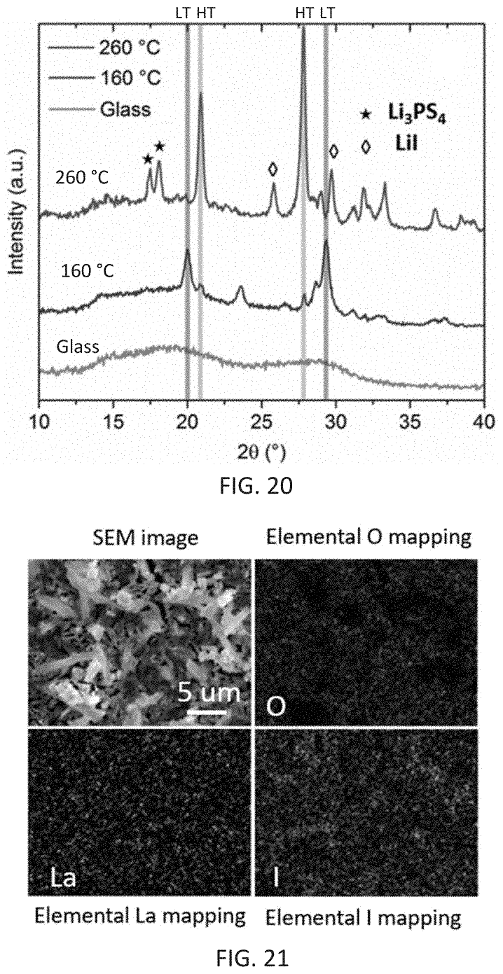

A differential thermal analysis (DTA) curve of the amorphous powder after mechanical milling was obtained (FIG. 19). The curve shows peaks at ˜180° C (Tc1) and ˜230° C (Tc2), corresponding to the onset temperature of crystallization of the low-temperature (LT) phase and high-temperature (HT) phase, respectively. XRD patterns of the glass phase (bottom), LT-LPSBI (middle), and HT-LPSBI (top) are shown in FIG. 20. The vertical lines show the locations of the two strongest diffraction peaks of the LT and HT phases, as indicated.

### Example 3

### Li₇La₃Zr₂O₁₂-LiI Electrolyte

A 2 Li₇La₃Zr₂O₁₂-0.5 LiI (LLZO-LiI) electrolyte was prepared by ball milling La₃Li₇O₁₂Zr₂ and LiI at 600 rpm for 40 hours, followed by heating at 160° C for 1 hour, as described in Example 1. FIG. 21 shows an SEM cross-sectional image of the electrolyte pellet pressed under 450 MPa and elemental mapping. The mapping shows that the Lil phase is accumulated on the LLZO particle surfaces.

In view of the many possible aspects to which the principles of the present disclosure may be applied, it should be recognized that the illustrated aspects are only preferred examples of the disclosure and should not be taken as limiting the scope. Rather, the scope of the present disclosure is defined by the following claims. We therefore claim as our invention all that comes within the scope and spirit of these claims.

We claim:

1. A solid electrolyte, comprising:
a compressed composite, wherein prior to cycling, the compressed composite comprises
(i) an amorphous matrix comprising an ionic compound or an alloy, the ionic compound or the alloy having a formula of Li_{y}Z, where Z is I, Br, Cl, F, Mg, B, N, Al, Si, Zn, Ag, Pt, or any combination thereof, and y is a value selected to provide the alloy or to provide the ionic compound with a neutral net charge; and
(ii) lithium-based electrolyte crystals at least partially embedded in the amorphous matrix, the lithium-based electrolyte crystals having a different chemical composition than the amorphous matrix,
wherein a surface portion of the compressed composite has a concentration of Z that is from 1% greater to 60% greater than an average concentration of Z within a bulk portion of the compressed composite.

2. The solid electrolyte of claim 1, wherein the compressed composite is formed under a pressure ≥450 MPa.

3. The solid electrolyte of claim 1, wherein the lithium-based electrolyte crystals comprise Li₆P₂S₈, Li₇La₃Zr₂O₁₂, Li_{1.3}Al_{0.3}Ti_{1.7}(PO₄)₃, Li₁₀GeP₂S₁₂, Li₁₀SiP₂S₁₂, Li₁₀SiP₂S₁₂, Li_{9.54}Si_{1.74}P_{1.44}S_{11.7}Cl_{0.3}, Li_{9.6}P₃S₁₂, Li₆PS₅Cl, Li₆PS₅Br, Li₆PS₅I, Li₇P₃S₁₁, Li₃PS₄, or any combination thereof.

4. The solid electrolyte of claim 1, wherein the lithium-based electrolyte crystals further comprise Z.

5. The solid electrolyte of claim 1, wherein Z is I, Br, Cl, F, or any combination thereof.

6. The solid electrolyte of claim 1, wherein a molar ratio q of the amorphous matrix to the lithium-based electrolyte crystals is from greater than zero to 1.

7. The solid electrolyte of claim 6, wherein q is 0.1 to 1.

8. The solid electrolyte of claim 6 wherein q is 0.3 to 1.

9. The solid electrolyte of claim 6, wherein the compressed composite comprises Li₇P₂S₈Q₁₋ₓZₓ, where:
Q is I, Br, Cl, F, Mg, B, N, Al, Si, Zn, Ag, Pt, or any combination thereof;
Q and Z are different;
the amorphous matrix comprises q(Li_{y}Z); and
the lithium-based electrolyte crystals comprise Li_{7-qy}P₂S₈Q₁₋ₓZ_{x-q}, where q≤x≤1.

10. The solid electrolyte of claim 9, wherein:
Z comprises I; and
y=1.

11. The solid electrolyte of claim 10, wherein:
Q is Br;
q=0.3 to 1;
the compressed composite comprises Li₇P₂S₈Br₁₋ₓIₓ; and
the lithium-based electrolyte crystals comprise Li_{7-q}P₂S₈Br₁₋ₓI_{x-q}, where q≤x≤1.

12. The solid electrolyte of claim 6, wherein:
the amorphous matrix comprises q(Li_{y}Z);
q=0.3 to 1; and
the lithium-based electrolyte crystals comprise Li₇La₃Zr₂O₁₂.

13. A solid-state battery, comprising:
a cathode,
an anode, an anode current collector, or an anode and an anode current collector; and
a solid electrolyte according to claim 1.

14. The solid-state battery of claim 13, wherein the surface portion of the compressed composite is oriented toward the anode or anode current collector.

15. The solid state battery of claim 13, wherein:
the compressed composite comprises Li₇P₂S₈Br₁₋ₓIₓ;
the amorphous matrix comprises qLiI; and
the lithium-based electrolyte crystals have a chemical formula Li_{7-q}P₂S₈Br₁₋ₓI_{x-q},
where 0.1≤q≤1 and q≤x≤1.

16. A method for making a solid electrolyte according to claim 1, comprising:
forming a mixture by combining stoichiometric amounts of one or more lithium-based electrolyte precursors and a compound comprising Z;
milling the mixture for a first period of time to form a powder;
heating the powder at a temperature of from 20° C to 260° C under an inert atmosphere for a second period of time to form a composite comprising the amorphous matrix and the lithium-based electrolyte crystals at least partially embedded in the amorphous matrix; and
compressing the composite under a pressure 450 MPa for at least one minute to form the compressed composite.

17. The method of claim 16, wherein the one or more lithium-based electrolyte precursors comprise (i) Li₂S and P₂S₅, or (ii) Li₇La₃Zr₂O₁₂.

18. The method of claim 17, wherein:
the compressed composite comprises Li₇P₂S₈Q₁₋ₓZₓ, where Q and Z independently are I, Br, Cl, or F, and 0≤x≤1; and
forming the mixture comprises combining stoichiometric amounts of Li₂S, P₂S₅, LiZ and LiQ.

19. The method of claim 18, wherein:
Z is I;
Q is Br;
0.5≤x≤1; and
combining stoichiometric amounts of Li₂S, P₂S₅, LiZ, and LiZ comprises combining 3 parts Li₂S, 1 part P₂S₅, x parts LiI, and 1-x parts LiBr.

20. The method of claim 16, wherein:
(i) the temperature is from 100° C to 160° C; or
(ii) the inert atmosphere comprises argon, nitrogen, helium, or a combination thereof; or
(iii) the first period of time is from 20 hours to 60 hours; or
(iv) the second period of time is from 30 minutes to 2 hours; or
(v) any combination of (i), (ii), (iii), and (iv).
